(19) United States
(12) Patent Application Publication
(10) Pub. No.: US 2026/0247364 A1
(43) Pub. Date: Aug. 20, 2026

(54) METHOD AND DEVICE FOR RECEIVING MULTI-RA A-MPDU IN WIRELESS LAN SYSTEM

(71) Applicant: LG Electronics Inc., Seoul (KR)

(72) Inventors: Yelin YOON, Seoul (KR); Insun JANG, Seoul (KR); Jinsoo CHOI, Seoul (KR); Sunhee BAEK, Seoul (KR); Geonhwan KIM, Seoul (KR)

(21) Appl. No.: 19/470,967

(22) PCT Filed: Apr. 9, 2024
(86) PCT No.: PCT/KR2024/004761

§ 371 Date: Sep. 30, 2025

(30) Foreign Application Priority Data
Apr. 18, 2023 (KR) 10-2023-0050926
Apr. 21, 2023 (KR) 10-2023-0052942

(51) Int. Cl. H04W 72/0453; H04W 84/12

(52) U.S. Cl. CPC H04W 72/0453; H04W 84/12

(57) ABSTRACT

A method and a device for receiving a multi-RA A-MPDU in a wireless LAN system are proposed. Specifically, a first and a second receiving STA receive a PPDU from a transmitting STA. The first and the second receiving STA decode the PPDU. The PPDU includes a signal field and a first A-MPDU. The signal field includes a first RU allocation subfield. The first RU allocation subfield includes information on the number of RAs configured in the first A-MPDU and the size of an RU or an MRU to which the first A-MPDU is allocated. The RAs configured in the first A-MPDU include a first RA for the first receiving STA and a second RA for the second receiving STA.

### TECHNICAL FIELD

This specification relates to a technique for receiving a Multi-RA A-MPDU in a wireless LAN system, and more specifically, to a method and device for configuring a Multi-RA A-MPDU that can be transmitted to two or more STAs with one A-MPDU to solve low latency traffic.

### BACKGROUND ART

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

In a new WLAN standard, an increased number of spatial streams may be used. In this case, in order to properly use the increased number of spatial streams, a signaling technique in the WLAN system may need to be improved.

### DISCLOSURE

### Technical Problem

This specification proposes a method and device for receiving a Multi-RA A-MPDU in a wireless LAN system.

### Technical Solution

An example of this specification proposes a method for receiving a Multi-RA A-MPDU.

This embodiment may be performed in a network environment that supports a next-generation wireless LAN system (Ultra High Reliability (UHR) wireless LAN system or next Wi-Fi). The next-generation wireless LAN system is an improved version of the 802.11be system and can satisfy backward compatibility with the 802.11be system.

This embodiment is performed at a receiving STA, and the receiving STA may correspond to at least one station (STA). The transmitting STA may correspond to an access point (AP).

This embodiment proposes a method for configuring a Multi-RAA-MPDU that can be transmitted to two or more STAs with one A-MPDU to solve low latency traffic. In particular, the present embodiment proposes a method for configuring the number of RAs that can be included in the Multi-RA A-MPDU and a size of the RU to which the Multi-RA A-MPDU is allocated based on a RU allocation subfield of a signal field.

First and second receiving stations (STAs) receive a Physical Layer Protocol Data Unit (PPDU) from a transmitting STA.

The first and second receiving STAs decode the PPDU.

The PPDU includes a signal field and a first Aggregate-MAC protocol data unit (A-MPDU).

The signal field includes a first Resource Unit (RU) allocation subfield. The first RU allocation subfield includes information on a number of Receiver Addresses (RAs) set in the first A-MPDU and a size of a RU or Multiple Resource Unit (MRU) to which the first A-MPDU is allocated.

The RAs set in the first A-MPDU include a first RA for the first receiving STA and a second RA for the second receiving STA.

The PPDU may further include a second A-MPDU.

The signal field may further include a second RU allocation subfield. The second RU allocation subfield may include information on a size of a RU or MRU to which the second A-MPDU is allocated.

A RA set in the second A-MPDU may only include a third RA for a third receiving STA.

Here, the first A-MPDU may correspond to a Multi-RA A-MPDU that has two (or more than two) RAs and can be transmitted to two (or more than two) STAs. The second A-MPDU may correspond to a conventional A-MPDU that has only one RA and can be transmitted to only one STA. That is, the first A-MPDU may be transmitted to the first and second receiving STAs, and the second A-MPDU may be transmitted to the third receiving STA.

That is, the present embodiment proposes a method of configuring a Multi-RA A-MPDU that can transmit one A-MPDU to two or more STAs by including two or more RAs in one A-MPDU in order to transmit low latency traffic more quickly.

### Advantageous Effects

According to the embodiment proposed in this specification, by newly defining a Disregarded value of the RU allocation subfield, the number of RAs set in a Multi-RA A-MPDU and the size of the allocated RU or MRU can be known, so that the AP can effectively preemptively transmit (transmit with priority) low latency traffic. This has the effect of reducing latency more efficiently by supporting differentiated transmission for STAs with different QoS by utilizing A-MPDU, which is an important transmission technology of Wi-Fi.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 shows an example of a multi-link (ML).

FIG. 5 shows an example of a physical protocol data unit or physical layer (PHY) protocol data unit (PPDU) transmitted/received by an STA of the present disclosure.

FIG. 6 is a diagram illustrating the layout of resource units (RUs) used for a 20 MHz PPDU.

FIG. 7 is a diagram illustrating the layout of resource units (RUs) used for 40 MHz PPDU.

FIG. 8 is a diagram illustrating the layout of resource units (RUs) used for an 80 MHz PPDU.

FIG. 9 shows an operation related to UL-MU,

FIG. 10 illustrates an example of channels used/supported/defined within the 2.4 GHz band.

FIG. 11 illustrates an example of channels used/supported/defined within the 5 GHZ band.

FIG. 12 illustrates an example of channels used/supported/defined within the 6 GHz band.

FIG. 13 shows an example of a header of a MAC frame.

FIG. 14 illustrates an example of a modified transmission device and/or receiving device of the present specification.

FIG. 15 illustrates an example of an A-MPDU format.

FIG. 16 illustrates an example of an A-MPDU transmission method in a downlink environment.

FIG. 17 illustrates an example of a multi-RA A-MPDU transmission method in a downlink environment.

FIG. 19 illustrates an example of an RU Allocation subfield defined in an 802.11be WLAN system.

FIG. 20 illustrates an example of an RU Allocation subfield defined in an 802.11be WLAN system.

FIG. 21 illustrates an example of an RU Allocation subfield defined in an 802.11be WLAN system.

FIG. 22 illustrates an example of an RU Allocation subfield defined in an 802.11be WLAN system.

FIG. 23 illustrates an example of the RU Allocation subfield defined in an 802.11be WLAN system.

FIG. 24 illustrates an example of the RU Allocation subfield defined in an 802.11be WLAN system.

FIG. 25 illustrates an example of the RU Allocation subfield defined in an 802.11be WLAN system.

FIG. 26 illustrates an example of the RU Allocation subfield defined in an 802.11be WLAN system.

FIG. 27 illustrates an example of the RU Allocation subfield defined in an 802.11be WLAN system.

FIG. 28 illustrates an example tone plan with allocated RUs for transmission of a Multi-RA A-MPDU in an 80 MHz bandwidth.

FIG. 29 illustrates an example of the arrangement of A-MPDU subframes within a Multi-RA A-MPDU.

FIG. 30 illustrates an example of the arrangement of A-MPDU subframes within a Multi-RA A-MPDU to reduce frame decoding time.

FIG. 31 illustrates an example of receiving a Block ACK through the transmission of a Block ACK Request frame.

FIG. 32 is a flowchart illustrating the operation of a transmitting device according to the present embodiment.

FIG. 33 is a flowchart illustrating the operation of a receiving device according to the present embodiment.

FIG. 34 is a flowchart illustrating a procedure for transmitting a multi-RA A-MPDU according to the present embodiment.

FIG. 35 is a flowchart illustrating a procedure for receiving a multi-RA A-MPDU according to the present embodiment.

### MODE FOR INVENTION

In the present disclosure, “A or B” may mean “only A”, “only B” or “both A and B”. In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, a parenthesis used in the present disclosure may mean “for example”. Specifically, when indicated as “control information (UHR-signal field)”, it may mean that “UHR-signal field” is proposed as an example of the “control information”. In other words, the “control information” of the present disclosure is not limited to “UHR-signal field”, and “UHR-signal field” may be proposed as an example of the “control information”. In addition, when indicated as “control information (i.e., UHR-signal field)”, it may also mean that “UHR-signal field” is proposed as an example of the “control information”.

Also, “a/an” as used in this disclosure can mean “at least one” or “one or more.” Also, a term ending with “(s)” can mean “at least one” or “one or more.”

Also, the expressions “based on” or “on the basis of” or “according to” as used in this disclosure mean “based at least in part on,” and do not mean “based sonly on.”

Technical features described individually in one figure in the present disclosure may be individually implemented, or may be simultaneously implemented.

The following example of the present disclosure may be applied to various wireless communication systems. For example, the following example of the present disclosure may be applied to a wireless local area network (WLAN) system. For example, the present disclosure may be applied to the IEEE 802.11a/g/n/ac/ax/be/bn standard. In addition, an example of the present disclosure can also be applied to a next-generation wireless LAN standard that enhances the Ultra High Reliability (UHR) standard or IEEE 802.11bn. In addition, the example of the present disclosure may also be applied to a new WLAN standard enhanced from the EHT standard or the IEEE 802.11be standard. In addition, the example of the present disclosure may be applied to a mobile communication system. For example, it may be applied to a mobile communication system based on long term evolution (LTE) depending on a 3rd generation partnership project (3GPP) standard and based on evolution of the LTE. In addition, the example of the present disclosure may be applied to a communication system of a 5G NR standard based on the 3GPP standard.

Hereinafter, in order to describe a technical feature of the present disclosure, a technical feature applicable to the present disclosure will be described.

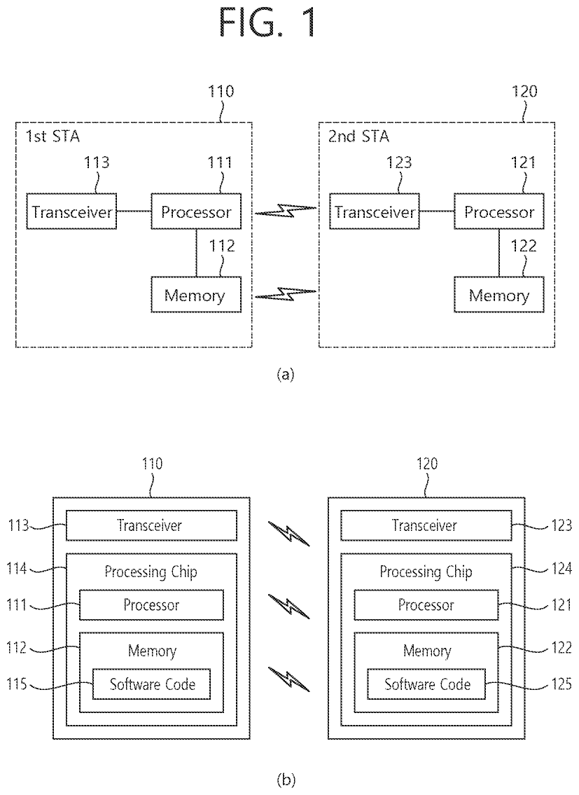

FIG. 1 shows an example of a transmitting apparatus and/or receiving apparatus of the present disclosure.

In the example of FIG. 1, various technical features described below may be performed. FIG. 1 relates to at least one station (STA). For example, STAs 110 and 120 of the present disclosure may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present disclosure may also be called in various terms such as a network, a base station, a node-B, an access point (AP), a repeater, a router, a relay, or the like. The STAs 110 and 120 of the present disclosure may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present disclosure may serve as the AP and/or the non-AP. In the present disclosure, the AP may be indicated as an AP STA.

The STAs 110 and 120 of the present disclosure may support various communication standards together in addition to the IEEE 802.11 standard. For example, a communication standard (e.g., LTE, LTE-A, 5G NR standard) or the like based on the 3GPP standard may be supported. In addition, the STA of the present disclosure may be implemented as various devices such as a mobile phone, a vehicle, a personal computer, or the like. In addition, the STA of the present disclosure may support communication for various communication services such as voice calls, video calls, data communication, and self-driving (autonomous-driving), or the like.

The STAs 110 and 120 of the present disclosure may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the disclosure described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the disclosure described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the disclosure described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied the STA; for and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present disclosure will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present disclosure may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present disclosure, an uplink may imply a link for communication from a non-AP STA to an AP STA, and an uplink PPDU/packet/signal or the like may be transmitted through the uplink. In addition, in the present disclosure, a downlink may imply a link for communication from the AP STA to the non-AP STA, and a downlink PPDU/packet/signal or the like may be transmitted through the downlink.

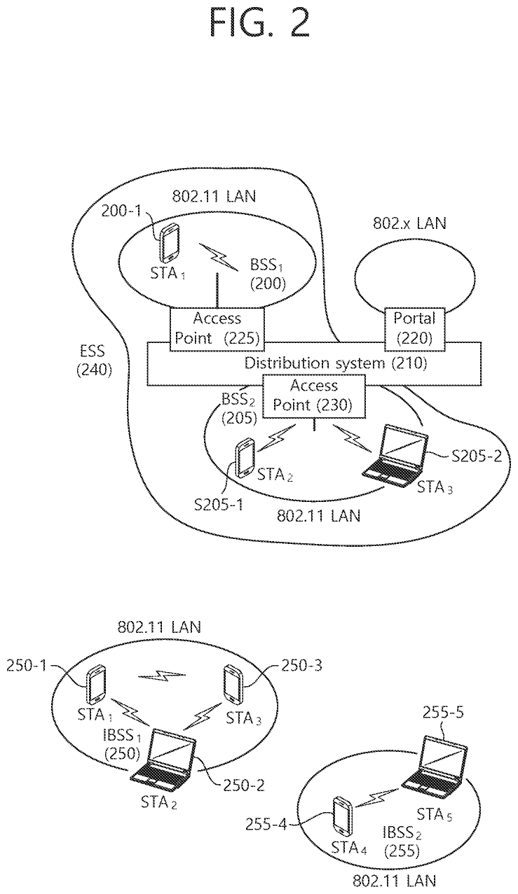

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and an STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, an AP 225, 230 providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

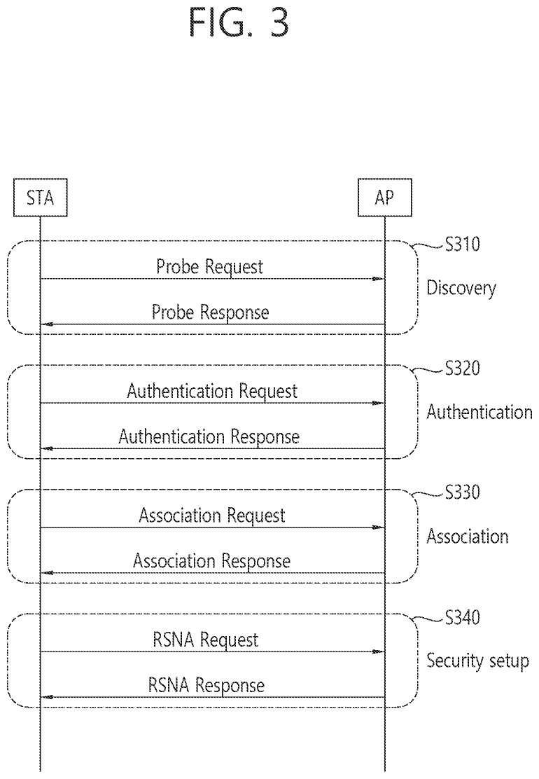

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

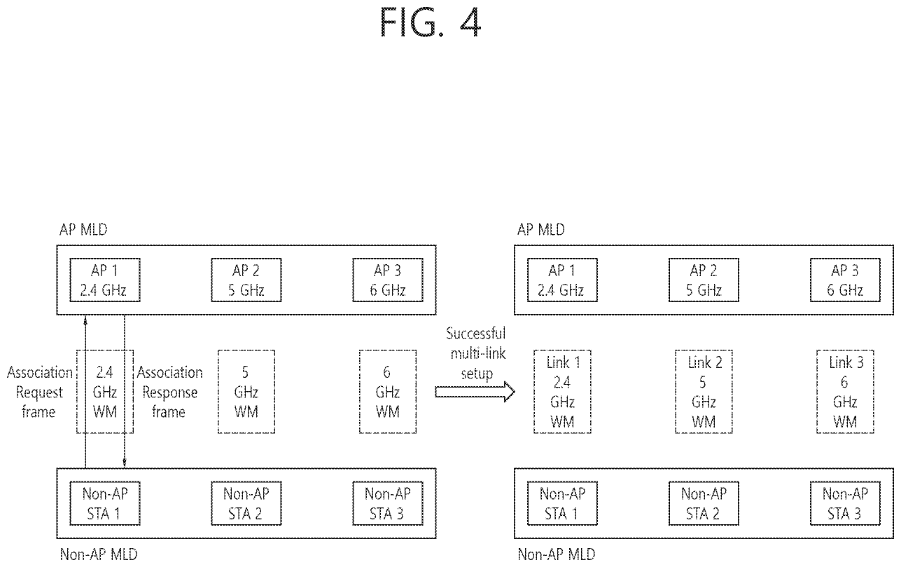

In S340, the STA may perform a security setup process. The security setup process in S340 may include a process of setting up a private key through four-way handshaking, for example, through an extensible authentication protocol over LAN (EAPOL) frame. FIG. 4 shows an example of a multi-link (ML).

As illustrated in FIG. 4, multiple multi-link devices (MLDs) can perform communication via a remote link. The MLD can be classified into an AP MLD including multiple AP STAs and a non-AP MLD including multiple non-AP STAs. That is, the AP MLD can include affiliated APs (i.e., AP STAs), and the non-AP MLD can include affiliated STAs (i.e., non-AP STAs, or user-STAs).

The multi-link can include a first link and a second link, and different channels/subchannels/frequency resources can be allocated to the first and second links. The first and second multi-links can be identified through a link ID of 4 bits (or other n bits). The first and second links may be configured in the same 2.4 GHz, 5 GHZ, or 6 GHz band. Alternatively, the first link and the second link may be configured in different bands.

The AP MLD of FIG. 4 includes three affiliated APs. In the example of FIG. 4, AP1 may operate in the 2.4 GHz band, AP2 may operate in the 5 GHz band, and AP3 may operate in the 6 GHz band. In the example of FIG. 4, the first link in which AP1 and non-AP1 operate may be defined as a channel/subchannel/frequency resource within the 2.4 GHz band. In addition, in the example of FIG. 4, the second link in which AP2 and non-AP2 operate may be defined as a channel/subchannel/frequency resource within the 5 GHz band. In addition, in the example of FIG. 4, the third link where AP3 and non-AP3 operate can be defined as a channel/subchannel/frequency resource within the 6 GHz band.

In the example of FIG. 4, AP1 can start a multi-link setup procedure (ML setup procedure) by transmitting an association request frame to non-AP STA1. In the example of FIG. 4, non-AP STA1 can transmit an association response frame in response to the association request frame. Each AP (e.g., AP1/2/3) illustrated in FIG. 4 may be identical to the AP illustrated in FIG. 1 and/or FIG. 2, and each non-AP (e.g., non-AP1/2/3) illustrated in FIG. 4 may be identical to the STA (i.e., user-STA or non-AP STA) illustrated in FIG. 1 and/or FIG. 2.

The specific features of the present disclosure are not limited to the specific features of FIG. 4. That is, the number of links can be defined in various ways, and multiple links can be defined in various ways within at least one band.

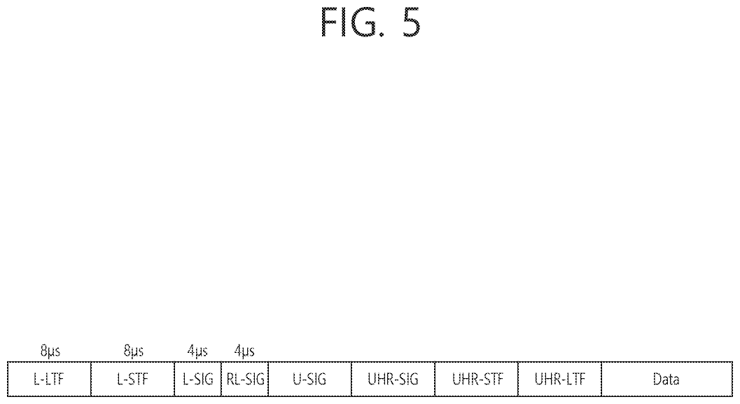

FIG. 5 shows an example of a physical protocol data unit or physical layer (PHY) protocol data unit (PPDU) transmitted/received by an STA of the present disclosure.

An STA (e.g., an AP STA, a non-AP STA, an AP MLD, a non-AP MLD) of the present disclosure can transmit and/or receive a PPDU of FIG. 5. The PPDU described in the present disclosure can have, for example, a structure of FIG. 5. In addition, the PPDU described in the present disclosure can be called by various names such as a transmission PPDU, a reception PPDU, a first type or an Nth type PPDU, etc. The PPDU described in the present disclosure can be used in a WLAN system defined according to IEEE 802.11bn and/or a next-generation WLAN system that improves IEEE 802.11bn.

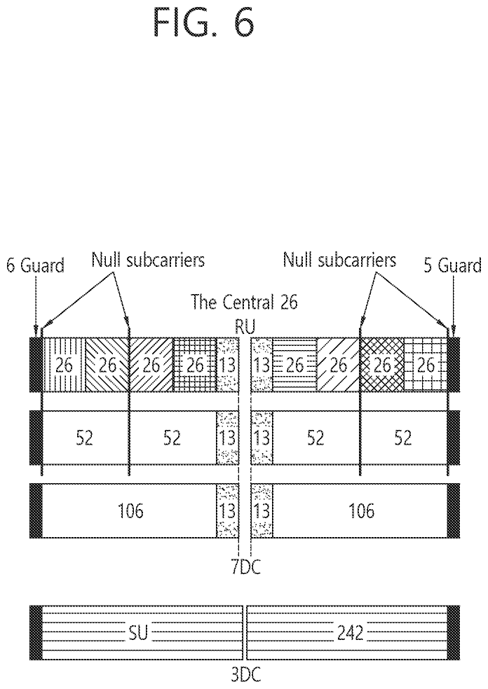

The PPDU of FIG. 5 can be related to various PPDU types used in a UHR system. For example, the example of FIG. 5 can be used for at least one of single-user (SU) mode/type/transmission, multi-user (MU) mode/type/transmission, and null-data packet (NDP) mode/type/transmission related to channel sounding. For example, if the example of FIG. 5 is related to NDP, the data field illustrated can be omitted. If the PPDU of FIG. 5 is used for trigger-based (TB) mode, UHR-SIG of FIG. 6 can be omitted. In other words, an STA that has received a trigger frame for uplink-MU (UL-MU) communication can transmit a PPDU with UHR-SIG omitted in the example of FIG. 5.

In FIG. 5, L-STF or UHR-LTF may be called a preamble or a physical preamble, and may be generated/transmitted/received/acquired/decoded in the physical layer (included in the transmitting/receiving STA).

Each block illustrated in FIG. 5 may be called a field/subfield/signal, etc. The names of these fields/subfields/signals may be legacy short training field (L-STF), legacy long training field (L-LTF), legacy signal (L-SIG), repeated L-SIG (RL-SIG), universal signal (U-SIG), UHR-signal (UHR-SIG), etc., as illustrated in FIG. 5.

A subcarrier spacing of the L-STF, L-LTF, L-SIG, RL-SIG, U-SIG, and UHR-SIG fields of FIG. 5 may be determined as 312.5 kHz, and a subcarrier spacing of the UHR-STF, UHR-LTF, and Data fields may be determined as 78.125 kHz. That is, a tone index (or subcarrier index) of the L-STF, L-LTF, L-SIG, RL-SIG, U-SIG, and UHR-SIG fields may be expressed in unit of 312.5 kHz, and a tone index (or subcarrier index) of the UHR-STF, UHR-LTF, and Data fields may be expressed in unit of 78.125 KHz.

In the PPDU of FIG. 5, the L-LTF and the L-STF may be the same as those in the conventional fields (for example, non-HT LTF and non-HT STF defined in conventional WLAN standards).

The L-SIG field of FIG. 5 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-high throughput (HT), high throughput (HT), very high throughput (VHT) PPDU, extremely high throughput (EHT) PPDU or UHR PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI, EHT PPDU or the UHR PPDU, the value of the length field may be determined as a multiple of 3, and for the high efficiency (HE) PPDU, the value of the length field may be determined as “a multiple of 3”+1 or “a multiple of 3”+2. In other words, the LENGTH field in an UHR PPDU is set to a value satisfying the condition that the remainder is zero when LENGTH is divided by 3

For example, the (non-AP and AP) STA may apply BCC encoding based on a 1/2 coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier {subcarrier index −21, −7, +7, +21} and a DC subcarrier {subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {~1, −1, −1, 1} to a subcarrier index {−28, −27, +27, +28}. The aforementioned signal may be used for channel estimation in the frequency domain corresponding to {−28, −27, +27, +28}.

For example, the (non-AP and AP) STA may generate an RL-SIG generated in the same manner as the L-SIG. BPSK modulation may be applied to the RL-SIG. The (non-AP and AP) STA may know that the RX PPDU is the HE PPDU, EHT PPDU, or the UHR PPDU, based on the presence of the RL-SIG. In other words, a receiving (non-AP and AP) STA can know that a received PPDU is one of a HE PPDU, an EHT PPDU, and a UHR PPDU if RL-SIG is present. In other words, a receiving (non-AP and AP) STA can know that a received PPDU is one of a non-HT PPDU, an HT PPDU, and a VHT PPDU if RL-SIG is not present. In other words, the RL-SIG field is a repeat of the L-SIG field and is used to differentiate a UHR PPDU from a non-HT PPDU, HT PPDU, and VHT PPDU.

A universal SIG (U-SIG) may be inserted after the RL-SIG of FIG. 6. The U-SIG may be called in various terms such as a first SIG field, a first SIG, a first type SIG, a control signal, a control signal field, a first (type) control signal, common control field, common control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 us. Each symbol of the U-SIG may be used to transmit the 26-bit information. For example, each symbol of the U-SIG may be transmitted/received based on 52 data tomes and 4 pilot tones.

Through the U-SIG for example, A-bit information (e.g., 52 un-coded bits) may be transmitted. A first symbol of the U-SIG may transmit first X-bit information (e.g., 26 un-coded bits) of the A-bit information, and a second symbol of the U-SIG may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, ‘000000’.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits (for example, 000 value) may indicate that the TX/RX PPDU is an EHT PPDU. Also, a second value of the PHY version identifier of 3 bits (for example, 001 value) may indicate that the TX/RX PPDU is a UHR PPDU.

In other words, when the (AP/non-AP) STA transmits an EHT PPDU, the 3-bit PHY version identifier can be set to the first value, and when the (AP/non-AP) STA transmits a UHR PPDU, the 3-bit PHY version identifier can be set to the second value. In other words, the receiving (AP/non-AP) STA can determine that the received PPDU is an EHT PPDU based on the PHY version identifier having the first value, and can determine that the received PPDU is a UHR PPDU based on the PHY version identifier having the second value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a transmission opportunity (TXOP) length and information related to a BSS color ID.

For example, if a UHR PPDU is classified into various types (e.g., type related to SU transmission (performed based on UL or DL), type related to DL transmission, type related to NDP transmission, type related to DL non-MU-MIMO, type related to DL MU-MIMO, type related to multi-AP operation, type related to coordinated beamforming (Co-BF), spatial reuse (SR), type related to coordinated OFDMA (C-OFDMA), type related to coordinated TDMA (Co-TDMA)), information about the type of the UHR PPDU (e.g., 2-bit or 3-bit information) can be included in the version-dependent bits of the U-SIG.

For example, the U-SIG may include: 1) a bandwidth field including information related to a bandwidth; 2) a field including information related to an modulation and coding scheme (MCS) applied to UHR-SIG; 3) an indication field including information regarding whether a dual subcarrier modulation (DCM) scheme is applied to UHR-SIG; 4) a field including information related to the number of symbol used for UHR-SIG; 5) a field including information regarding whether the UHR-SIG is generated across a full band; 6) a field including information related to a type of UHR-LTF/STF; and 7) information related to a field indicating an UHR-LTF length and a CP length.

Preamble puncturing may be applied to the PPDU of FIG. 5. The preamble puncturing implies that puncturing is applied to part (e.g., a secondary 20 MHz band) of the full band. For example, when an 80 MHz PPDU is transmitted, an STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80MHaz band within the 160 MHz band (or 80+80 MHz band).

Information related to the preamble puncturing applied to the PPDU may be included in U-SIG and/or UHR-SIG. For example, a first field of the U-SIG may include information related to a contiguous bandwidth, and second field of the U-SIG may include information related to the preamble puncturing applied to the PPDU.

For example, the U-SIG and the UHR-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an UHR-SIG contiguous to the first U-SIG may include information related to a preamble puncturing applied to the second 80 MHz band (i.e., information related to a preamble puncturing pattern), and an UHR-SIG contiguous to the second U-SIG may include information related to a preamble puncturing (i.e., information related to a preamble puncturing pattern) applied to the first 80 MHz band.

Additionally or alternatively, the U-SIG and the UHR-SIG may include the information related to the preamble puncturing, based on the following method. The U-SIG may include information related to a preamble puncturing (i.e., information related to a preamble puncturing pattern) for all bands. That is, the UHR-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The UHR-SIG of FIG. 5 may include control information for the receiving STA. The UHR-SIG may be transmitted through at least one symbol, and one symbol may have a length of 4 us. Information related to the number of symbols used for the UHR-SIG may be included in the U-SIG.

UHR-SIG provides an additional signal to the U-SIG field to enable STA to interpret/decode UHR PPDU. UHR-SIG field may include U-SIG overflow bits that are commonly applied to all users. In addition, UHR-SIG field includes resource allocation information, so that STA can look-up resources used in fields including data field/UHR-STF/UHR-LTF (i.e., UHR modulated fields of a UHR PPDU).

Frequency resources of UHR-LTF, UHR-STF, and data fields illustrated in FIG. 5 may be determined based on RUs (resource units) defined by multiple subcarriers/tones. That is, UHR-LTF, UHR-STF, and data fields of the present disclosure may be transmitted/received through RUs (resource units) defined by multiple subcarriers/tones.

FIG. 6 is a diagram illustrating the layout of resource units (RUs) used for a 20 MHz PPDU. That is, the UHR-LTF, UHR-STF, and/or data fields included in the 20 MHz PPDU may be transmitted/received through at least one of the various RUs defined in FIG. 6.

As illustrated in the uppermost part of FIG. 6, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

Meanwhile, the layout of the RUs in FIG. 6 may be used not only for a multiple users (MUs) but also for a single user (SU), in which case one 242-unit may be used and three DC tones may be inserted as illustrated in the lowermost part of FIG. 6.

Although FIG. 6 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones). In this specification, N-RU may be represented as N-tone RU, etc. For example, 26-RU may be represented as 26-tone RU.

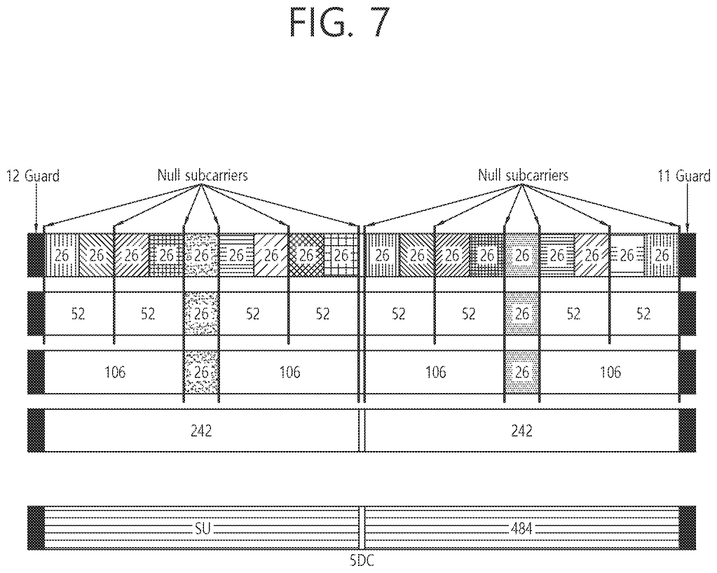

FIG. 7 is a diagram illustrating the layout of resource units (RUs) used for 40 MHz PPDU.

Similarly to FIG. 6 in which RUs having various sizes are used, a 26-RU, a 52-RU, a 106-RU, a 242-RU, a 484-RU, and the like may be used in an example of FIG. 7. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 7, when the layout of the RUs is used for a single user, a 484-RU may be used. The specific number of RUs may be changed similarly to FIG. 6.

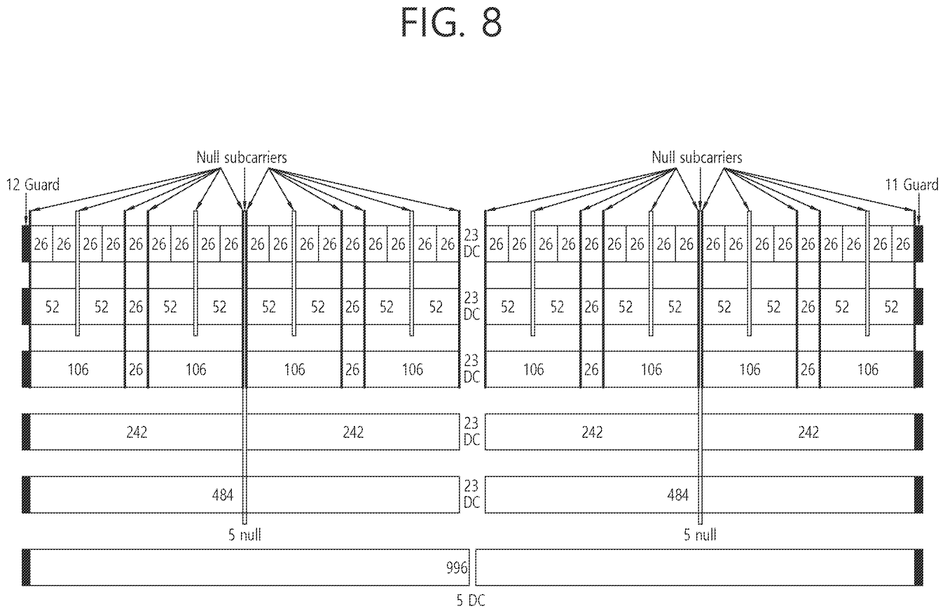

FIG. 8 is a diagram illustrating the layout of resource units (RUs) used for an 80 MHz PPDU. The layout of resource units (RUs) used in this specification may vary. For example, the layout of resource units (RUs) used in the 80 MHz band may vary.

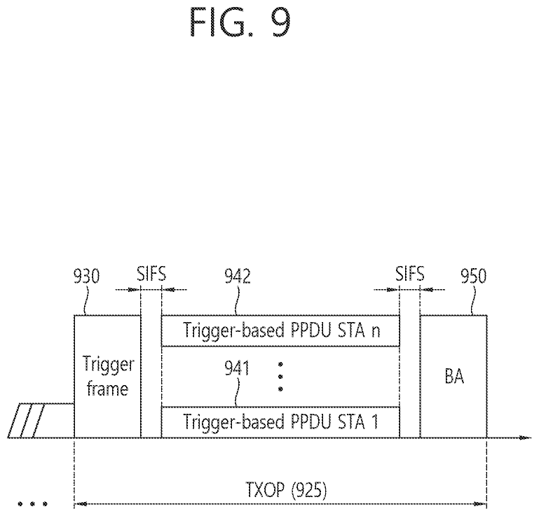

FIG. 9 shows an operation related to UL-MU. As illustrated, a transmitting STA (e.g., AP) can perform channel access through contending (i.e., backoff operation) and transmit a trigger frame (930). That is, the transmitting STA (e.g., AP) can transmit a PPDU including a trigger frame (930). When a PPDU including a trigger frame is received, a TB (trigger-based) PPDU is transmitted after a delay of SIFS.

TB PPDUs (941, 942) are transmitted at the same time and can be transmitted from multiple STAs (e.g., User STAs) whose AIDs are indicated in the Trigger frame (930). The ACK frame (950) for the TB PPDU can be implemented in various forms.

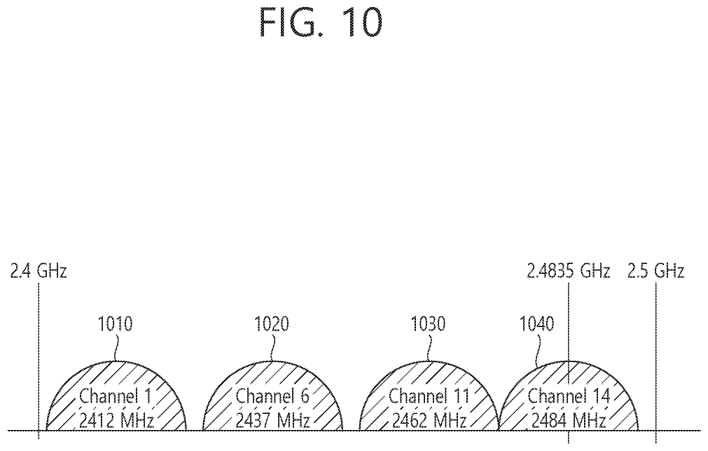

FIG. 10 illustrates an example of channels used/supported/defined within the 2.4 GHZ band.

The 2.4 GHz band may also be referred to by other names, such as “first band.” Furthermore, the 2.4 GHz band may refer to a frequency range in which channels with center frequencies adjacent to 2.4 GHz (e.g., channels with center frequencies between 2.4 and 2.5 GHz) are used/supported/defined.

The 2.4 GHz band may include multiple 20 MHz channels. The 20 MHz within the 2.4 GHz band may have multiple channel indices (e.g., indices 1 through 14). For example, the center frequency of a 20 MHz channel assigned channel index 1 may be 2.412 GHz, the center frequency of a 20 MHz channel assigned channel index 2 may be 2.417 GHz, and the center frequency of a 20 MHz channel assigned channel index N may be (2.407+0.005*N) GHz. The channel indices may be referred to by various names, such as channel numbers. The specific numerical values of the channel indices and center frequencies may change.

FIG. 10 exemplarily illustrates four channels within the 2.4 GHz band. The illustrated first frequency region (1010) to fourth frequency region (1040) may each include one channel. For example, the first frequency region (1010) may include channel 1 (a 20 MHz channel having an index of 1). In this case, the center frequency of channel 1 may be set to 2412 MHz. The second frequency region (1020) may include channel 6. In this case, the center frequency of channel 6 may be set to 2437 MHz. The third frequency region (1030) may include channel 11. In this case, the center frequency of channel 11 may be set to 2462 MHz. The fourth frequency region (1040) may include channel 14. In this case, the center frequency of channel 14 may be set to 2484 MHz.

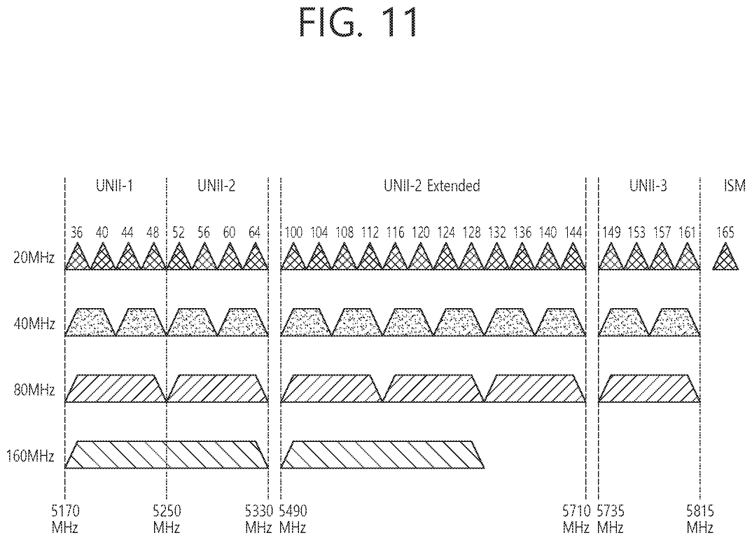

FIG. 11 illustrates an example of channels used/supported/defined within the 5 GHz band.

The 5 GHz band may be referred to by other names, such as a second band/band, etc. The 5 GHz band may refer to a frequency range in which channels with center frequencies greater than or equal to 5 GHz and less than 6 GHz (or less than 5.9 GHz) are used/supported/defined. Alternatively, the 5 GHz band may include multiple channels between 4.5 GHz and 5.5 GHz. The specific figures shown in FIG. 11 are subject to change.

Multiple channels within the 5 GHz band include Unlicensed National Information Infrastructure (UNII)-1, UNII-2, UNII-3, and ISM. UNII-1 may be referred to as UNII Low. UNII-2 may include frequency ranges called UNII Mid and UNII-2Extended. UNII-3 may be referred to as UNII-Upper.

Within the 5 GHz band, multiple channels can be configured, and the bandwidth of each channel can be variously configured, such as 20 MHz, 40 MHz, 80 MHz, or 160 MHz. For example, the 5170 MHz to 5330 MHz frequency domain/range within UNII-1 and UNII-2 can be divided into eight 20 MHz channels. The 5170 MHz to 5330 MHz frequency domain/range can be divided into four channels through a 40 MHz frequency domain. The 5170 MHz to 5330 MHz frequency domain/range can be divided into two channels through an 80 MHz frequency domain. Alternatively, the 5170 MHz to 5330 MHz frequency domain/range can be divided into one channel through a 160 MHz frequency domain.

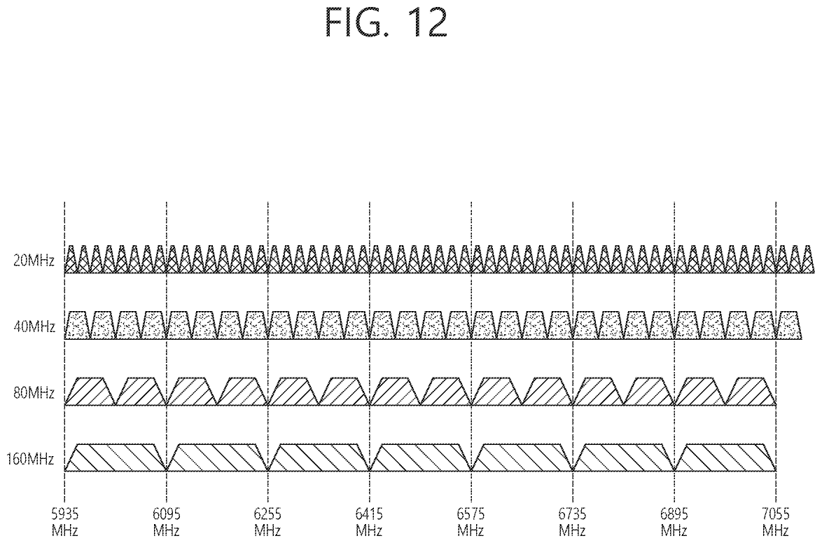

FIG. 12 illustrates an example of channels used/supported/defined within the 6 GHz band.

The 6 GHz band may be referred to by other names, such as the third band/band. The 6 GHz band may refer to a frequency range where channels with center frequencies higher than 5.9 GHz are used, supported, and defined. The specific values shown in FIG. 12 are subject to change.

For example, the 20 MHz channel in FIG. 12 may be defined starting from 5.940 GHz. Specifically, the leftmost channel among the 20 MHz channels in FIG. 12 may have an index of 1 (or channel index, channel number, etc.) and be assigned a center frequency of 5.945 GHZ. In other words, the center frequency of channel index N may be determined as (5.940+0.005*N) GHz.

Accordingly, the indexes (or channel numbers) of the 20 MHz channels of FIG. 12 may be 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. Also, according to the (5.940+0.005*N) GHz rule mentioned above, the indexes of the 40 MHz channels in FIG. 12 may be 3, 11, 19, 27, 35, 43, 51, 59, 67, 75, 83, 91, 99, 107, 115, 123, 131, 139, 147, 155, 163, 171, 179, 187, 195, 203, 211, 219, 227.

Hereinafter, the structure and type/subtype of MAC frame are described.

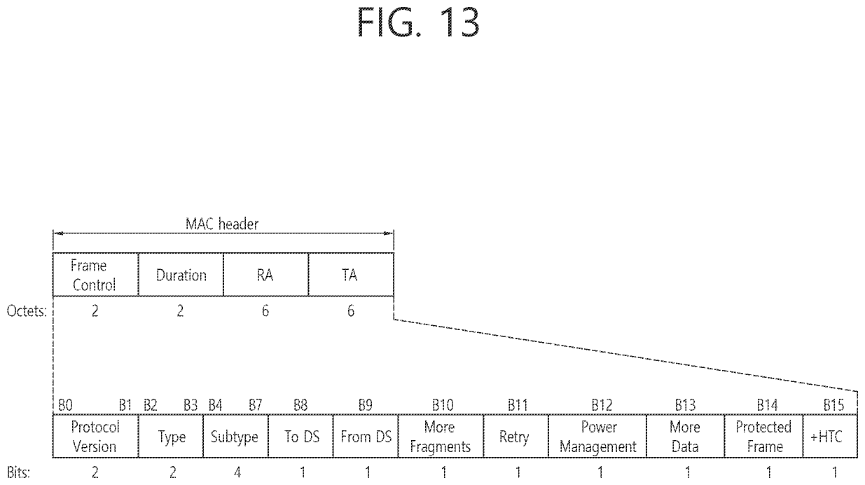

FIG. 13 shows an example of a header of a MAC frame. As shown, the MAC frame can include a frame control field/information of 2 octets in length, a duration field/information of 2 octets in length, an receiver address (RA) field/information of 6 octets in length, and a transmitter address (TA) field/information of 6 octets in length. As shown in FIG. 13, the four fields can be consecutive to each other. The MAC header of FIG. 13 can be modified in various ways, and a new field can be inserted between the four fields shown, or at least one of the fields shown can be omitted.

The MAC header shown in FIG. 13 can be located at the very front of the MAC frame. That is, the MAC frame may include a MAC header as in FIG. 13 and a MAC body field/information that is continuous to the MAC header. The MAC frame including the MAC header of FIG. 13 is inserted/included in the data field of the PPDU (e.g., UHR PPDU) illustrated in FIG. 5.

The MAC frame included in the data field of the PPDU of this disclosure may be classified into various types. For example, the MAC frame of this disclosure may be classified into a control frame, a management frame, and a data frame.

For example, the management frame includes association request, association response, reassociation request, reassociation response, probe request, probe response, beacon, disassociation, authentication, and deauthentication frames/signals defined in the conventional WLAN. For the management frame, the values of the type fields (B3 and B2) of FIG. 8 are set to 00. Also, the values of the subtype fields (B7, B6, B5, B4) of FIG. 8 are as follows: association request (0000), association response (0001), reassociation request (0010), reassociation response (0011), probe request (0100), probe response (0101), beacon (1000), disassociation (1010), authentication (1011), deauthentication (1100).

For example, the control frame includes trigger beamforming report poll, NDP announcement (NDPA), control frame extension, control wrapper, block Ack request (BlockAckReq), Block Ack (BlockAck), PS-Poll, RTS, CTS, Ack, CF-end frames/signals defined in conventional WLAN. For the control frame, the values of the type fields (B3 and B2) of FIG. 8 are set to 01. Also, the values of the subtype fields (B7, B6, B5, B4) of FIG. 8 are as follows: trigger (0010), beamforming report poll (0100), NDP announcement (0101), control frame extension (0110), control wrapper (0111), BlockAckReq (1000), BlockAck (1001), PS-Poll (1010), RTS (1011), CTS (1100), Ack (1101), CF-End (1110).

For example, the data frame includes (QoS) Data, (QoS) Null, etc. defined in the conventional WLAN. For the management frame, the values of the type fields (B3 and B2) of FIG. 13 are set to 10.

The MAC frame/signal used in this disclosure can be identified through the type field/information and subtype field/information described above. For example, a “trigger frame” in this disclosure may mean a MAC frame in which the type bits B3 and B2 bits in the frame control field of the MAC header are set to 01, and the subtype bits B7, B6, B5, and B4 bits in the frame control field are set to 0010. Various MAC frames described in this disclosure are inserted/included in the data fields of various PPDUs (e.g., HE/VHT/HE/EHT/UHR PPDUs).

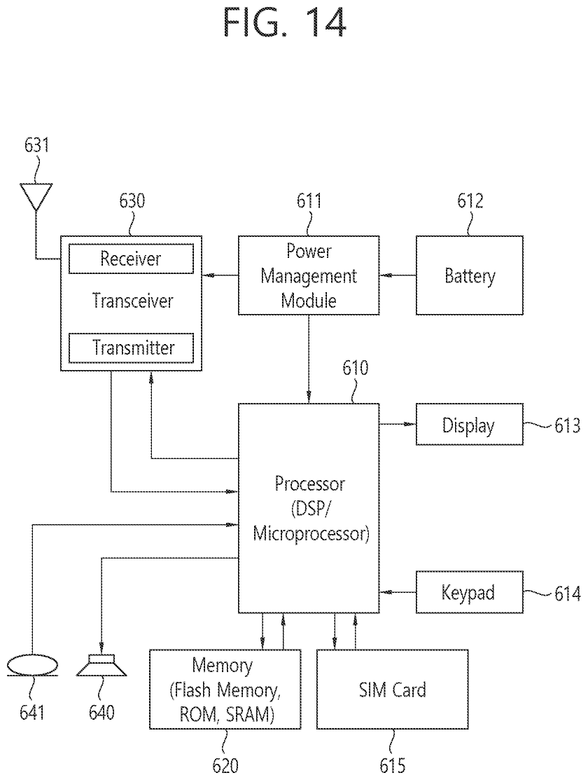

FIG. 14 shows a modified example of a transmitting device and/or a receiving device of the present disclosure.

The devices (e.g., AP STA, non-AP STA) shown in FIGS. 1 to 4 can be modified as shown in FIG. 14. The transceiver 630 of FIG. 14 can be identical to the transceiver 113, 123 of FIG. 1. The transceiver 630 of FIG. 14 can include a receiver and a transmitter.

The processor 610 of FIG. 14 can be identical to the processor 111, 121 of FIG. 1. Alternatively, the processor 610 of FIG. 14 can be identical to the processing chip 114, 124 of FIG. 1.

The memory 150 of FIG. 14 may be the same as the memory 112, 122 of FIG. 1.

Alternatively, the memory 150 of FIG. 14 may be a separate external memory different from the memory 112, 122 of FIG. 1.

Referring to FIG. 14, the power management module 611 manages power for the processor 610 and/or the transceiver 630. The battery 612 supplies power to the power management module 611. The display 613 outputs the result processed by the processor 610. The keypad 614 receives input to be used by the processor 610. The keypad 614 may be displayed on the display 613. The SIM card 615 may be an integrated circuit used to securely store an international mobile subscriber identity (IMSI) and its associated keys, which are used to identify and authenticate subscribers in mobile devices such as mobile phones and computers.

Referring to FIG. 14, the speaker (640) may output sound-related results processed by the processor 610. The microphone (641) may receive sound-related input to be used by the processor 610.

Below, an Aggregate MPDU (A-MPDU) applicable to this specification is described.

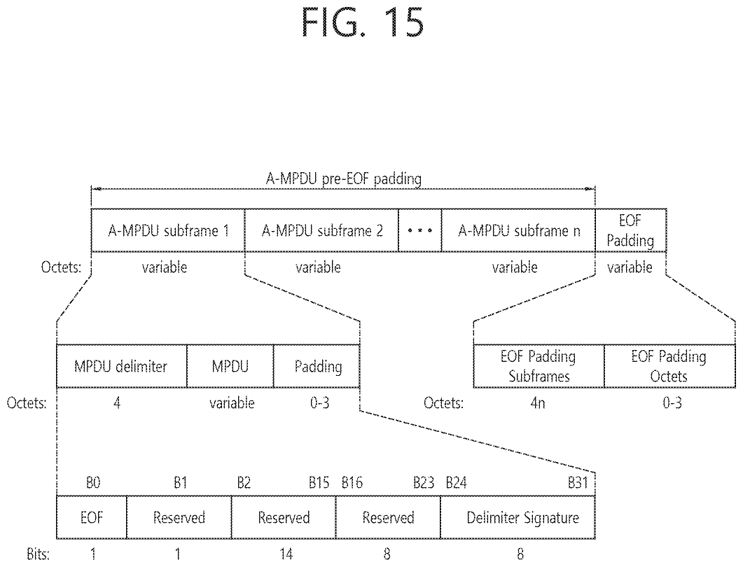

FIG. 15 illustrates an example of an A-MPDU format.

Referring to FIG. 15, an A-MPDU includes a sequence of at least one A-MPDU subframe and a variable amount of End Of Frame (EOF) padding. Each A-MPDU subframe optionally includes an MPDU delimiter positioned before the MPDU. In the A-MPDU, each non-final A-MPDU subframe may have padding octets added to create a subframe with a length that is a multiple of 4 octets. The contents of these octets are not specified.

An EOF Padding subframe contains zero or more EOF padding subframes. An EOF Padding subframe is an A-MPDU subframe whose MPDU Length field is 0 and whose EOF field is 1. A-MPDU pre-EOF padding represents the contents of an A-MPDU that does not include the EOF padding field.

The maximum length of an A-MPDU in an HT PPDU is 65,535 octets. The maximum length of an A-MPDU in a DMG PPDU is 262,143 octets. The maximum length of the A-MPDU pre-EOF padding in a VHT PPDU is 1,048,575 octets. The maximum length of the A-MPDU pre-EOF padding in an HE PPDU is 6,500,631 octets. The maximum length of the A-MPDU pre-EOF padding in an EHT PPDU is 15,523,200 octets. The length of an A-MPDU addressed to a specific STA may be further limited.

The MPDU delimiter contains an EOF/Tag field and an MPDU Length field. The EOF/Tag field indicates the end of the frame when the MPDU Length field is 0. The EOF/Tag field is set to 1 in A-MPDU subframes where the MPDU Length field is 0 and is used to pad the A-MPDU in a VHT or HE PPDU.

The MPDU Length field indicates the length of the MPDU in octets, and is set to 0 if there are no more MPDUs.

In a Non-DMG PPDU, an A-MPDU is a sequence of A-MPDU subframes carried in a single PPDU using one of the following combinations of RXVECTOR or TXVECTOR parameter values:
FORMAT parameter set to VHT
FORMAT parameter set to HT_MF or HT_GF and AGGREGATION parameter set to 1.
FORMAT parameter set to SIG, SIG_DUP_1M, or SIG_DUP_2M and AGGREGATION parameter set to 1.
FORMAT parameter set to HE_SU, HE_MU, HE_TB, or HE_ER_SU.
FORMAT parameter set to EHT_MU or EHT_TB

A-MPDUs carried in HE SU PPDUs, HE ER SU PPDUs, HE TB PPDUs, and HE MU PPDUs may contain MPDUs with different values in the TID field (Multi-TID A-MPDUs and ack-enabled single-TID A-MPDUs).

All MPDUs within an A-MPDU are addressed to the same Radio Access Point (RA). All MPDUs within an A-MPDU have the same Transport Assignment (TA). All QoS data frames within an A-MPDU with a TID for which HT immediate block acknowledgment agreement exists have the same value in the Acknowledgement Policy Indicator subfield of the QoS Control field.

All protected MPDUs within an A-MPDU have the same key ID.

The Duration/ID field in the MAC header of all MPDUs within an A-MPDU carries the same value. The Duration/ID field in the MAC header of the MPDUs included in the VHT MU PPDU, HE MU PPDU, and EHT MU PPDU carries the same value.

The reference point for the Duration/ID field is the end of the PPDU carrying the MPDU. For A-MPDU Aggregation, setting the Duration/ID field to the same value means that each MPDU consistently specifies the same NAV setting.

The VHT MU PPDU, SIG MU PPDU, HE MU PPDU, and EHT MU PPDU do not carry more than one A-MPDU containing one or more MPDUs requesting an immediate response if the immediate response is carried in a non-PPDU. The HE TB PPDU is not an EHT TB PPDU. The HE MU PPDU and EHT MU PPDU may carry more than one A-MPDU, each containing one or more MPDUs requesting an immediate response, if the immediate response is carried in a HE TB PPDU or EHT TB PPDU.

The Block Ack mechanism improves channel efficiency by aggregating multiple ACKs into a single frame. Using the Block Ack mechanism, an STA with data to transmit is called a sender, and the recipient of that data is called a receiver.

The Ack Policy Indicator subfield, along with other information, identifies the ack policy, i.e., the action to be taken when transmitting an MPDU. If the MPDU is a non-A-MPDU frame, it is designated as Normal Ack, and if the MPDU is not a non-A-MPDU frame, it is designated as Implicit BAR.

### Embodiments Applicable to this Specification

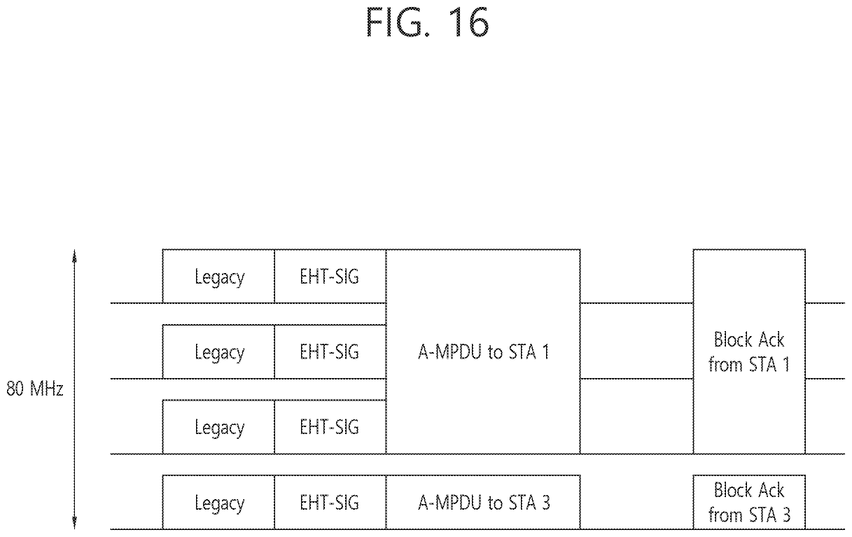

FIG. 16 illustrates an example of an A-MPDU transmission method in a downlink environment.

An example of the A-MPDU transmission method currently defined in 802.11be is shown in FIG. 16. FIG. 16 illustrates a PPDU composed of an A-MPDU transmitted only to STA 1 in 60 MHz of the total bandwidth of 80 MHz by an AP in a downlink environment, and an A-MPDU transmitted to STA 3 in the remaining 20 MHz. Each A-MPDU is configured in a way that it can have only one RA, so it can be transmitted to only one STA. The transmission order of A-MPDUs is determined based on EDCA, and at this time, low-latency traffic that must be transmitted earlier than other data may exist. Currently, there is no method in 802.11be to effectively transmit low-latency traffic first, so a system that can process such packets more quickly needs to be proposed. In Wi-Fi, when data arrives, packets to be transmitted are queued and transmitted in the order they arrive according to AC category. For this reason, the existing A-MPDU transmission method has a problem in that it cannot transmit low-latency traffic packets quickly because it must transmit other packets first if there are other packets to be transmitted in the queue before the low-latency traffic packet. In a situation where transmission scheduling has already been done as in FIG. 16, even if there is low-latency traffic to be sent to STA 2, it is difficult to quickly transmit the PPDU to STA 2 because it must wait until the TXOPs of STA 1 and STA 3 are finished. In addition, if the PPDU to STA 2 is sent more aggressively (ahead of) the PPDUs to other STAs, problems such as fairness issues may arise.

To address this, this specification proposes a novel technique for transmitting low-latency traffic by including two or more RAs in an A-MPDU to transmit low-latency traffic more quickly. The values/names proposed in this specification may be modified and are not limited to the values/names described below. In addition, in this specification, STA includes non-AP STA and AP STA.

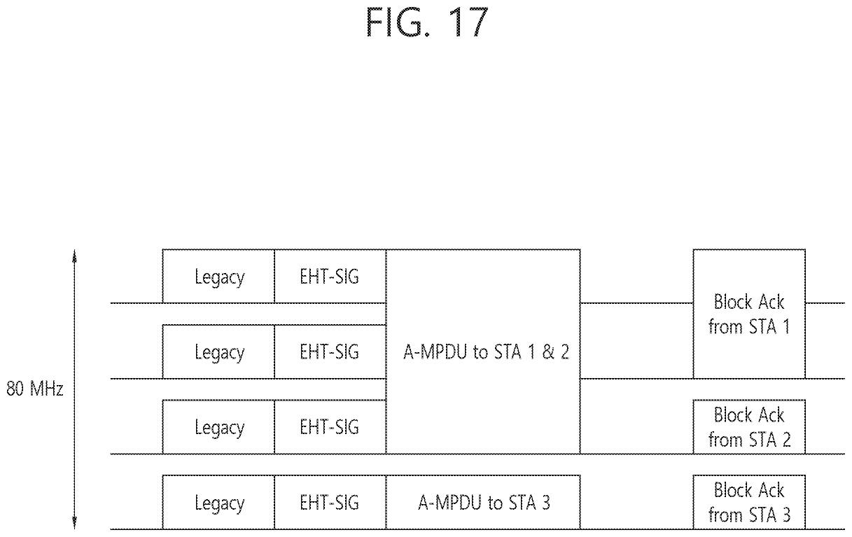

FIG. 17 illustrates an example of a multi-RA A-MPDU transmission method in a downlink environment.

This specification proposes a new Multi-RA A-MPDU that can be transmitted to two or more STAs with one A-MPDU. An example of a Multi-RA A-MPDU transmission method is shown in FIG. 17. FIG. 17 shows a pre-emption technique using Multi-RA A-MPDU when there is low-latency traffic that must be urgently sent to STA 2 while data to be sent to STA 1 and STA 3 is queued in a downlink environment.

Referring to FIG. 17, the AP transmits data in the form of Multi-RA A-MPDU to both STA 1 and STA 2 (not just to STA 1) at 60 MHz out of the 80 MHz bandwidth, and transmits the existing A-MPDU to STA 3 at the remaining 20 MHz.

If Multi-RA A-MPDU is introduced in a UHR wireless LAN system, the EHT-SIG of FIG. 17 can also be named UHR-SIG. In addition, all EHT-SIGs described below can be named UHR-SIG.

FIG. 18 shows an example of RU allocation of a Multi-RA A-MPDU.

FIG. 18 shows an example of how the Resource Unit (RU) Allocation subfield for transmission in FIG. 17 and the user data in the User field are actually mapped. First, in the RU Allocation subfield, it is notified that one 484+242-tone RU is an RU for transmission of a Multi-RA A-MPDU, and the data of STA 1 and STA 2 are allocated to the 484+242-tone RU and transmitted. Both methods set the STA-ID of the user field in the EHT-SIG field of the EHT MU PPDU to its own ID. That is, the ID of each STA participating in the transmission of the Multi-RA A-MPDU and the existing A-MPDU is set to the STA ID of the user field of the EHT-SIG.

The first method is to set the PPDU as above and then later distinguish in the MAC layer whether the A-MPDU has two or more RAs or one RA.

The second method is to configure a Multi-RA A-MPDU using the value of the RU Allocation subfield included in the EHT-SIG field. Multi-RA A-MPDUs can only be allocated in RUs greater than 242 RUs and are subject to the rule that they can include up to three STAs.

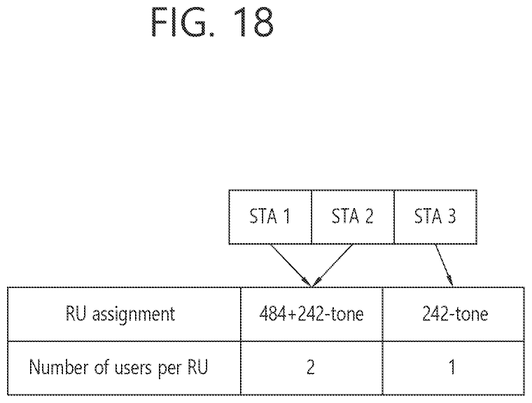

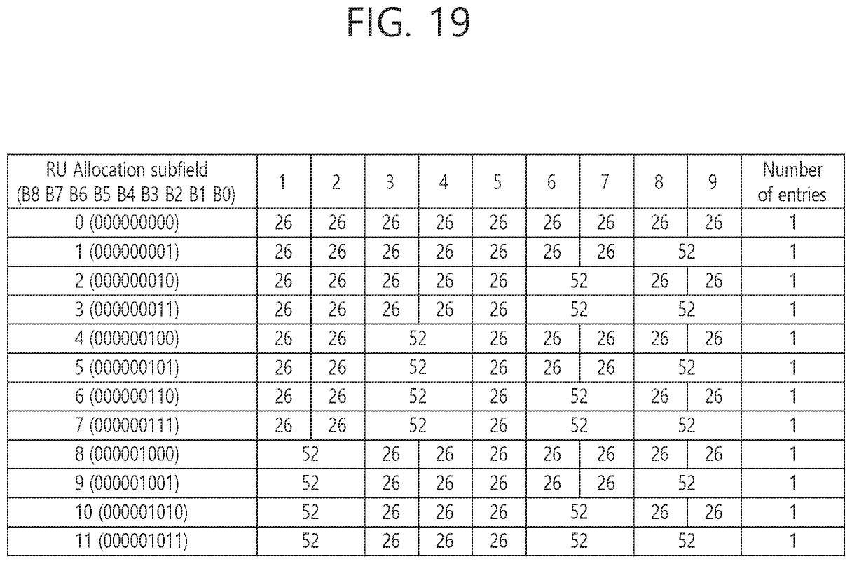

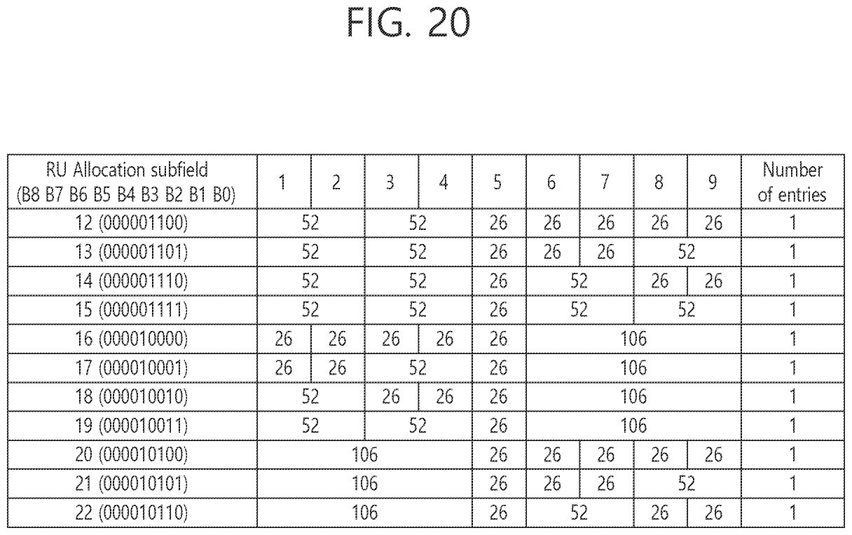

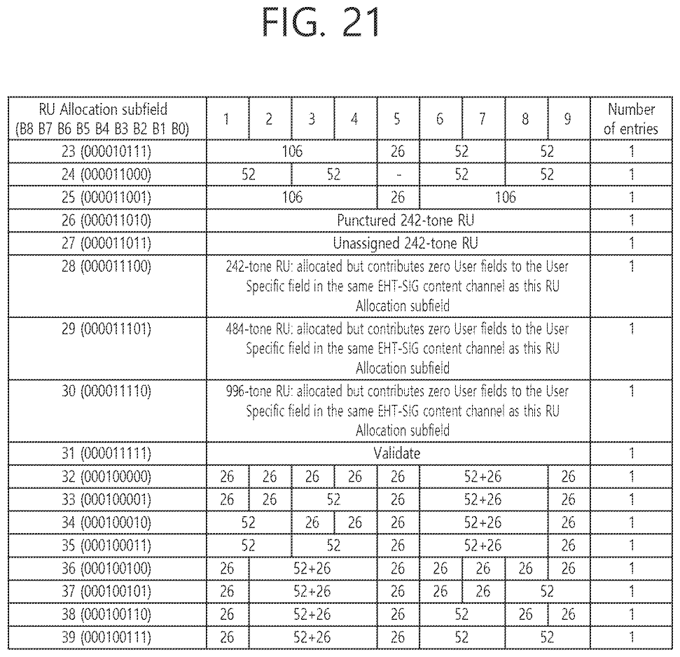

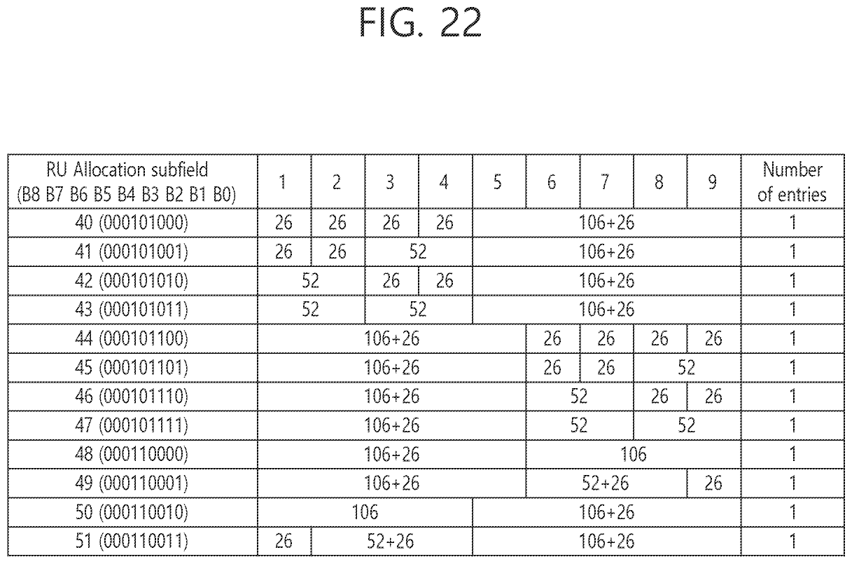

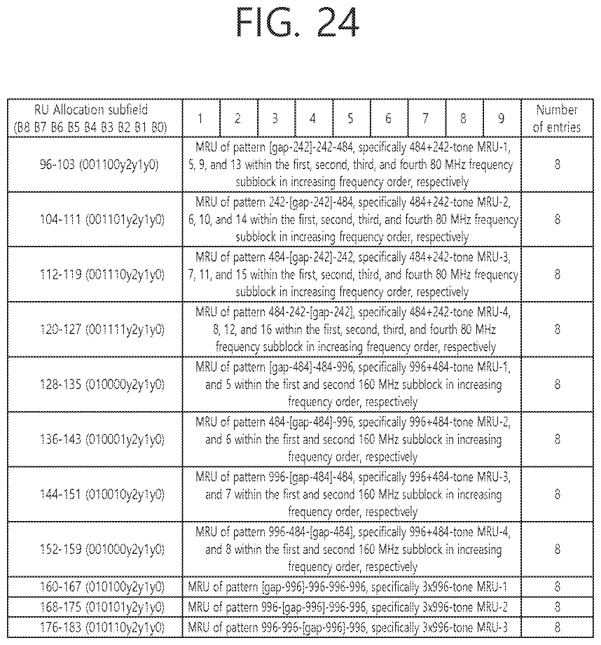

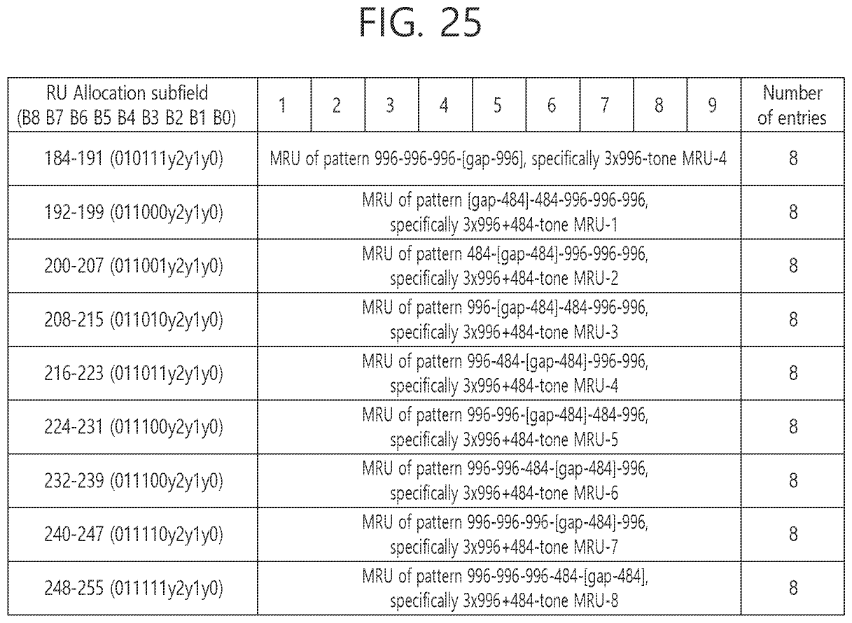

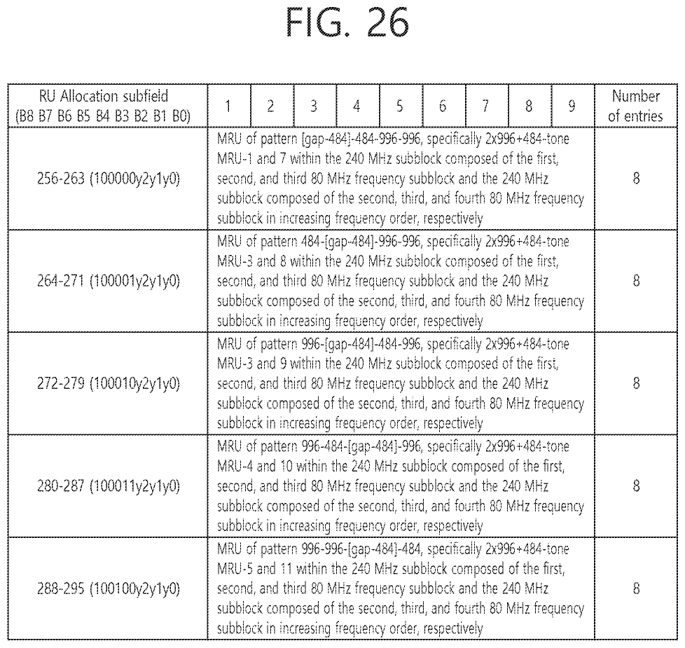

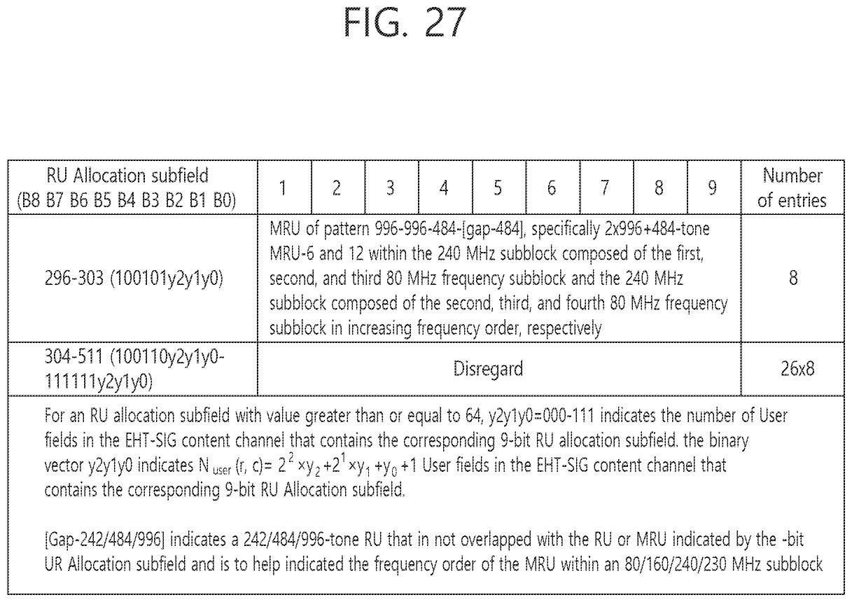

FIGS. 19 to 27 illustrates an example of an RU Allocation subfield defined in an 802.11be WLAN system.

The mapping from the 9-bit RU Allocation subfield to RU allocation and the number of User fields per RU or MRU contributed to the User Specific field of the same EHT-SIG content channel as the RU Allocation subfield are defined in FIGS. 19 to 27.

Referring to FIGS. 19 to 27, when the value of the RU Allocation subfield is 0 to 303, it indicates an allocation pattern of a specific RU or MRU, and when the value of the RU Allocation subfield is 304 to 511, it is set to Disregard.

The large-size MRUs defined for DL and UL non-OFMDA transmissions are as follows:
484+242-tone MRU, 996+484-tone MRU, 996+484+242-tone MRU, 2×996+484-tone MRU, 3×996-tone MRU, and 3×996+484-tone MRU

The large-size MRUs defined for DL and UL OFMDA transmissions are as follows:
484+242-tone MRU, 996+484-tone MRU, 2×996+484-tone MRU, 3×996-tone MRU, and 3×996+484-tone MRU (i.e., the 996+484+242-tone MRU is defined only for non-OFDMA transmissions).

The location of the large size MRU is fixed and defined as follows. Table 1 defines the index of the large size MRU in OFDMA 80 MHz PPDU and non-OFDMA 80 MHz PPDU.

TABLE 1

| MRU type | MRU index | Combinations |
|---|---|---|
| 484 + 242- | MRU 1 | 484-tone RU 2 + 242-tone RU 2; [(gap-242-tone RU) − 242- |
| tone MRU | | tone RU − 484-tone RU] |
| | MRU 2 | 484-tone RU 2 + 242-tone RU 1; [242-tone RU − (gap-242-tone |
| | | RU) − 484-tone RU] |
| | MRU 3 | 484-tone RU 1 + 242-tone RU 4; [484-tone RU − (gap-242-tone |
| | | RU) − 242-tone RU] |
| | MRU 4 | 484-tone RU 1 + 242-tone RU 3; [484-tone RU − 242-tone RU − |
| | | (gap-242-tone RU)] |

NOTE 1-
gap-242-tone RU is not part of an MRU and is used to indicate the size of a gap between or beside RUs that form the MRU.
NOTE 2-
non-OFDMA transmission, gap-242-tone RU indicates that one 20 MHz subchannel corresponding to gap-242-tone RU is punctured and is to help indicate the frequency order of the MRU in an 80 MHz PPDU.
NOTE 3-
OFDMA transmission, gap-242-tone RU indicates that one 20 MHz subchannel corresponding to gap-242-tone RU is either punctured or unassigned or assigned to other RUs or MRUs for data transmission, and is to help indicate the frequency order of the MRU within an 80 MHz EHT PPDU.

Tables 2 to 4 define the indices of large size MRUs in OFDMA 160 MHz PPDUs and non-OFDMA 160 MHz PPDUs.

TABLE 2

| MRU type | MRU index | Combinations |
|---|---|---|
| 484 + 242- | MRU 1 | 484-tone RU 2 + 242-tone RU 2; [(gap-242-tone RU) − 242- |
| tone MRU | | tone RU − 484-tone RU] in lower 80 MHz channel |
| (only for | MRU 2 | 484-tone RU 2 + 242-tone RU 1; [242-tone RU − (gap-242-tone |
| OFDMA) | | RU) − 484-tone RU] in lower 80 MHz channel |
| | MRU 3 | 484-tone RU 1 + 242-tone RU 4; [484-tone RU − (gap-242-tone |
| | | RU) − 242-tone RU] in lower 80 MHz channel |
| | MRU 4 | 484-tone RU 1 + 242-tone RU 3; [484-tone RU − 242-tone RU − |
| | | (gap-242-tone RU)] in lower 80 MHz channel |
| | MRU 5 | 484-tone RU 4 + 242-tone RU 6; [(gap-242-tone RU) − 242- |
| | | tone RU − 484-tone RU] in upper 80 MHz channel |
| | MRU 6 | 484-tone RU 4 + 242-tone RU 5; [242-tone RU − (gap-242-tone |
| | | RU) − 484-tone RU] in upper 80 MHz channel |
| | MRU 7 | 484-tone RU 3 + 242-tone RU 8; [484-tone RU − (gap-242-tone |
| | | RU) − 242-tone RU] in upper 80 MHz channel |
| | MRU 8 | 484-tone RU 3 + 242-tone RU 7; [484-tone RU − 242-tone RU − |
| | | (gap-242-tone RU)] in upper 80 MHz channel |

NOTE 1-
RU is not part of an MRU and is used to indicate the size of a gap between or beside RUs that form the MRU.
NOTE 2-
non-OFDMA transmission, gap-242/484-tone RU indicates that one or more 20 MHz subchannels corresponding to gap-242/484-tone RU are punctured and is to help indicate the frequency order of the MRU in a 160 MHz PPDU.
NOTE 3-
OFDMA transmission, gap-242/484-tone RU indicates that one or more 20 MHz subchannels corresponding to gap-242/484-tone RU are either punctured or unassigned or assigned to other RUs or MRUs for data transmission, and is to help indicate the frequency order of the MRU within a 160 MHz EHT PPDU.

TABLE 3

| MRU type | MRU index | Combinations |
|---|---|---|
| 996 + 484- | MRU 1 | 996-tone RU 2 + 484-tone RU 2; [(gap-484-tone RU) − 484- |
| tone MRU | | tone RU − 996-tone RU] |
| | MRU 2 | 996-tone RU 2 + 484-tone RU 1; [484-tone RU − (gap-484-tone |
| | | RU) − 996-tone RU] |
| | MRU 3 | 996-tone RU 1 + 484-tone RU 4; [996-tone RU − (gap-484-tone |
| | | RU) − 484-tone RU] |
| | MRU 4 | 996-tone RU 1 + 484-tone RU 3; [996-tone RU − 484-tone RU − |
| | | (gap-484-tone RU)] |

NOTE 1-
RU is not part of an MRU and is used to indicate the size of a gap between or beside RUs that form the MRU.
NOTE 2-
non-OFDMA transmission, gap-242/484-tone RU indicates that one or more 20 MHz subchannels corresponding to gap-242/484-tone RU are punctured and is to help indicate the frequency order of the MRU in a 160 MHz PPDU.
NOTE 3-
OFDMA transmission, gap-242/484-tone RU indicates that one or more 20 MHz subchannels corresponding to gap-242/484-tone RU are either punctured or unassigned or assigned to other RUs or MRUs for data transmission, and is to help indicate the frequency order of the MRU within a 160 MHz EHT PPDU.

TABLE 4

| MRU type | MRU index | Combinations |
|---|---|---|
| 996 + 484 + 242- | MRU 1 | 996-tone RU 2 + 484-tone RU 2 + 242-tone RU 2; [(gap- |
| tone MRU (only | | 242-tone RU) − 242-tone − RU 484-tone RU − 996-tone RU] |
| for non- | MRU 2 | 996-tone RU 2 + 484-tone RU 2 + 242-tone RU 1; [242- |
| OFDMA) | | tone RU − (gap-242-tone RU) − 484-tone RU − 996-tone |
| | | RU] |
| | MRU 3 | 996-tone RU 2 + 484-tone RU 1 + 242-tone RU 4; [484- |
| | | tone RU − (gap-242-tone RU) − 242-tone RU − 996-tone |
| | | RU] |
| | MRU 4 | 996-tone RU 2 + 484-tone RU 1 + 242-tone RU 3; [484- |
| | | tone RU − 242-tone RU − (gap-242-tone RU) − 996-tone |
| | | RU] |
| | MRU 5 | 996-tone RU 1 + 484-tone RU 4 + 242-tone RU 6; [996- |
| | | tone RU − (gap-242-tone RU) − 242-tone RU − 484-tone |
| | | RU] |
| | MRU 6 | 996-tone RU 1 + 484-tone RU 4 + 242-tone RU 5; [996- |
| | | tone RU − 242-tone RU − (gap-242-tone RU) − 484-tone |
| | | RU] |
| | MRU 7 | 996-tone RU 1 + 484-tone RU 3 + 242-tone RU 8; [996- |
| | | tone RU − 484-tone RU − (gap-242-tone RU) − 242-tone |
| | | RU] |
| | MRU 8 | 996-tone RU 1 + 484-tone RU 3 + 242-tone RU 7; [996- |
| | | tone RU − 484-tone RU − 242-tone RU − (gap-242-tone |
| | | RU)] |

NOTE 1-
RU is not part of an MRU and is used to indicate the size of a gap between or beside RUs that form the MRU.
NOTE 2-
non-OFDMA transmission, gap-242/484-tone RU indicates that one or more 20 MHz subchannels corresponding to gap-242/484-tone RU are punctured and is to help indicate the frequency order of the MRU in a 160 MHz PPDU.
NOTE 3-
OFDMA transmission, gap-242/484-tone RU indicates that one or more 20 MHz subchannels corresponding to gap-242/484-tone RU are either punctured or unassigned or assigned to other RUs or MRUs for data transmission, and is to help indicate the frequency order of the MRU within a 160 MHz EHT PPDU.

Tables 5 to 9 define the indices of large size MRUs in OFDMA 320 MHz PPDUs and non-OFDMA 320 MHz PPDUs.

TABLE 5

| MRU type | MRU index | Combinations |
|---|---|---|
| 484 + 242- | MRU 1 | 484-tone RU 2 + 242-tone RU 2; [(gap-242-tone RU) − 242- |
| tone MRU | | tone RU − 484-tone RU] in lower 80 MHz channel in lower 160 |
| (only for | | MHz |
| OFDMA) | MRU 2 | 484-tone RU 2 + 242-tone RU 1; [242-tone RU − (gap-242-tone |
| | | RU) − 484-tone RU] in lower 80 MHz channel in lower 160 |
| | | MHz |
| | MRU 3 | 484-tone RU 1 + 242-tone RU 4; [484-tone RU − (gap-242-tone |
| | | RU) − 242-tone RU] in lower 80 MHz channel in lower 160 |
| | | MHz |
| | MRU 4 | 484-tone RU 1 + 242-tone RU 3; [484-tone RU − 242-tone RU − |
| | | (gap-242-tone RU)] in lower 80 MHz channel in lower 160 |
| | | MHz |
| | MRU 5 | 484-tone RU 4 + 242-tone RU 6; [(gap-242-tone RU) − 242- |
| | | tone RU − 484-tone RU] in upper 80 MHz channel in lower 160 |
| | | MHz |
| | MRU 6 | 484-tone RU 4 + 242-tone RU 5; [242-tone RU − (gap-242-tone |
| | | RU) − 484-tone RU] in upper 80 MHz channel in lower 160 |
| | | MHz |
| | MRU 7 | 484-tone RU 3 + 242-tone RU 8; [484-tone RU − (gap-242-tone |
| | | RU) − 242-tone RU] in upper 80 MHz channel in lower 160 |
| | | MHz |
| | MRU 8 | 484-tone RU 3 + 242-tone RU 7; [484-tone RU − 242-tone RU − |
| | | (gap-242-tone RU)] in upper 80 MHz channel in lower 160 |
| | | MHz |
| | MRU 9 | 484-tone RU 6 + 242-tone RU 10; [(gap-242-tone RU) − 242- |
| | | tone RU − 484-tone RU] in lower 80 MHz channel in upper 160 |
| | | MHz |
| | MRU 10 | 484-tone RU 6 + 242-tone RU 9; [242-tone RU − (gap-242-tone |
| | | RU) − 484-tone RU] in lower 80 MHz channel in upper 160 |
| | | MHz |
| | MRU 11 | 484-tone RU 5 + 242-tone RU 12; [484-tone RU − (gap-242- |
| | | tone RU) − 242-tone RU] in lower 80 MHz channel in upper |
| | | 160 MHz |
| | MRU 12 | 484-tone RU 5 + 242-tone RU 11; [484-tone RU − 242-tone RU − |
| | | (gap-242-tone RU)] in lower 80 MHz channel in upper 160 |
| | | MHz |
| | MRU 13 | 484-tone RU 8 + 242-tone RU 14; [(gap-242-tone RU) − 242- |
| | | tone RU − 484-tone RU] in upper 80 MHz channel in upper 160 |
| | | MHz |
| | MRU 14 | 484-tone RU 8 + 242-tone RU 13; [242-tone RU − (gap-242- |
| | | tone RU) − 484-tone RU] in upper 80 MHz channel in upper |
| | | 160 MHz |
| | MRU 15 | 484-tone RU 7 + 242-tone RU 16; [484-tone RU − (gap-242- |
| | | tone RU) − 242-tone RU] in upper 80 MHz channel in upper |
| | | 160 MHz |
| | MRU 16 | 484-tone RU 7 + 242-tone RU 15; [484-tone RU − 242-tone RU − |
| | | (gap-242-tone RU)] in upper 80 MHz channel in upper 160 |
| | | MHz |

NOTE 1-
RU is not part of an MRU and is used to indicate the size of a gap between or beside RUs that form the MRU.
NOTE 2-
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3-
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

TABLE 6

| MRU type | MRU index | Combinations |
|---|---|---|
| 996 + 484- | MRU 1 | 996-tone RU 2 + 484-tone RU 2; [(gap-484-tone RU) − 484- |
| tone MRU | | tone RU − 996-tone RU] in lower 160 MHz |
| (only for | MRU 2 | 996-tone RU 2 + 484-tone RU 1; [484-tone RU − (gap-484-tone |
| OFDMA) | | RU) − 996-tone RU] in lower 160 MHz |
| | MRU 3 | 996-tone RU 1 + 484-tone RU 4; [996-tone RU − (gap-484-tone |
| | | RU) − 484-tone RU] in lower 160 MHz |
| | MRU 4 | 996-tone RU 1 + 484-tone RU 3; [996-tone RU − 484-tone RU − |
| | | (gap-484-tone RU)] in lower 160 MHz |
| | MRU 5 | 996-tone RU 4 + 484-tone RU 6; [(gap-484-tone RU) − 484- |
| | | tone RU − 996-tone RU] in upper 160 MHz |
| | MRU 6 | 996-tone RU 4 + 484-tone RU 5; [484-tone RU − (gap-484-tone |
| | | RU) − 996-tone RU] in upper 160 MHz |
| | MRU 7 | 996-tone RU 3 + 484-tone RU 8; [996-tone RU − (gap-484-tone |
| | | RU) − 484-tone RU] in upper 160 MHz |
| | MRU 8 | 996-tone RU 3 + 484-tone RU 7; [996-tone RU − 484-tone RU − |
| | | (gap-484-tone RU)] in upper 160 MHz |

NOTE 1-
RU is not part of an MRU and is used to indicate the size of a gap between or beside RUs that form the MRU.
NOTE 2-
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3-
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

TABLE 7

| MRU type | MRU index | Combinations |
|---|---|---|
| 2 × 996 + 484- | MRU 1 | 996-tone RU 2 + 996-tone RU 3 + 484-tone RU 2; [(gap-484- |
| tone MRU | | tone RU) − 484-tone RU − 996-tone RU − 996-tone RU − (gap- |
| | | 996-tone RU)] |
| | MRU 2 | 996-tone RU 2 + 996-tone RU 3 + 484-tone RU 1; [484-tone |
| | | RU − (gap-484-tone RU) − 996-tone RU − 996-tone RU − (gap- |
| | | 996-tone RU)] |
| | MRU 3 | 996-tone RU 1 + 996-tone RU 3 + 484-tone RU 4; [996-tone |
| | | RU − (gap-484-tone RU) − 484-tone RU − 996-tone RU − (gap- |
| | | 996-tone RU)] |
| | MRU 4 | 996-tone RU 1 + 996-tone RU 3 + 484-tone RU 3; [996-tone |
| | | RU − 484-tone RU − (gap-484-tone RU) − 996-tone RU − (gap- |
| | | 996-tone RU)] |
| | MRU 5 | 996-tone RU 1 + 996-tone RU 2 + 484-tone RU 6; [996-tone |
| | | RU − 996-tone RU − (gap-484-tone RU) − 484-tone RU − (gap- |
| | | 996-tone RU)] |
| | MRU 6 | 996-tone RU 1 + 996-tone RU 2 + 484-tone RU 5; [996-tone |
| | | RU − 996-tone RU − 484-tone RU − (gap-484-tone RU) − (gap- |
| | | 996-tone RU)] |
| | MRU 7 | 996-tone RU 3 + 996-tone RU 4 + 484-tone RU 4; [(gap-996- |
| | | tone RU) − (gap-484-tone RU) − 484-tone RU − 996-tone RU − |
| | | 996-tone RU] |
| | MRU 8 | 996-tone RU 3 + 996-tone RU 4 + 484-tone RU 3; [(gap-996- |
| | | tone RU) − 484-tone RU − (gap-484-tone RU) − 996-tone RU − |
| | | 996-tone RU] |
| | MRU 9 | 996-tone RU 2 + 996-tone RU 4 + 484-tone RU 6; [(gap-996- |
| | | tone RU) − 996-tone RU − (gap-484-tone RU) − 484-tone RU − |
| | | 996-tone RU] |
| | MRU 10 | 996-tone RU 2 + 996-tone RU 4 + 484-tone RU 5; [(gap-996- |
| | | tone RU) − 996-tone RU − 484-tone RU − (gap-484-tone RU) − |
| | | 996-tone RU] |
| | MRU 11 | 996-tone RU 2 + 996-tone RU 3 + 484-tone RU 8; [(gap-996- |
| | | tone RU) − 996-tone RU − 996-tone RU − (gap-484-tone RU) − |
| | | 484-tone RU] |
| | MRU 12 | 996-tone RU 2 + 996-tone RU 3 + 484-tone RU 7; [(gap-996- |
| | | tone RU) − 996-tone RU − 996-tone RU − 484-tone RU − (gap- |
| | | 484-tone RU)] |

NOTE 1-
RU is not part of an MRU and is used to indicate the size of a gap between or beside RUs that form the MRU.
NOTE 2-
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3-
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

TABLE 8

| MRU type | MRU index | Combinations |
|---|---|---|
| 3 × 996-tone | MRU 1 | 996-tone RU 2 + 996-tone RU 3 + 996-tone RU 4; [(gap-996- |
| MRU | | tone RU) − 996-tone RU − 996-tone RU − 996-tone RU] |
| | MRU 2 | 996-tone RU 1 + 996-tone RU 3 + 996-tone RU 4; [996-tone |
| | | RU − (gap-996-tone RU) − 996-tone RU − 996-tone RU] |
| | MRU 3 | 996-tone RU 1 + 996-tone RU 2 + 996-tone RU 4; [996-tone |
| | | RU − 996-tone RU − (gap-996-tone RU) − 996-tone RU] |
| | MRU 4 | 996-tone RU 1 + 996-tone RU 2 + 996-tone RU 3; [996-tone |
| | | RU − 996-tone RU − 996-tone RU − (gap-996-tone RU)] |

NOTE 1-
RU is not part of an MRU and is used to indicate the size of a gap between or beside RUs that form the MRU.
NOTE 2-
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3-
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

TABLE 9

| MRU type | MRU index | Combinations |
|---|---|---|
| 3 × 996 + 484- | MRU 1 | 996-tone RU 2 + 996-tone RU 3 + 996-tone RU 4 + 484-tone |
| tone MRU | | RU 2; [(gap-484-tone RU) − 484-tone RU − 996-tone RU − |
| | | 996-tone RU − 996-tone RU] |
| | MRU 2 | 996-tone RU 2 + 996-tone RU 3 + 996-tone RU 4 + 484-tone |
| | | RU 1; [484-tone RU − (gap-484-tone RU) − 996-tone RU − |
| | | 996-tone RU − 996-tone RU] |
| | MRU 3 | 996-tone RU 1 + 996-tone RU 3 + 996-tone RU 4 + 484-tone |
| | | RU 4; [996-tone RU − (gap-484-tone RU) − 484-tone RU − |
| | | 996-tone RU − 996-tone RU] |
| | MRU 4 | 996-tone RU 1 + 996-tone RU 3 + 996-tone RU 4 + 484-tone |
| | | RU 3; [996-tone RU − 484-tone RU − (gap-484-tone RU) − |
| | | 996-tone RU − 996-tone RU] |
| | MRU 5 | 996-tone RU 1 + 996-tone RU 2 + 996-tone RU 4 + 484-tone |
| | | RU 6; [996-tone RU − 996-tone RU − (gap-484-tone RU) − |
| | | 484-tone RU − 996-tone RU] |
| | MRU 6 | 996-tone RU 1 + 996-tone RU 2 + 996-tone RU 4 + 484-tone |
| | | RU 5; [996-tone RU − 996-tone RU − 484-tone RU − (gap-484- |
| | | tone RU) − 996-tone RU] |
| | MRU 7 | 996-tone RU 1 + 996-tone RU 2 + 996-tone RU 3 + 484-tone |
| | | RU 8; [996-tone RU − 996-tone RU − 996-tone RU − (gap-484- |
| | | tone RU) − 484-tone RU] |
| | MRU 8 | 996-tone RU 1 + 996-tone RU 2 + 996-tone RU 3 + 484-tone |
| | | RU 7; [996-tone RU − 996-tone RU − 996-tone RU − 484-tone |
| | | RU − (gap-484-tone RU)] |

NOTE 1-
RU is not part of an MRU and is used to indicate the size of a gap between or beside RUs that form the MRU.
NOTE 2-
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3-
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

Here, the second method described above is proposed to specify RUs using the bits (304-511) currently set to Disregard in the RU Allocation subfield. The way to specify the RU Allocation subfield depends on the number of RAs included in the Multi-RA A-MPDU and the size of the allocated RU, as described in Table 10. The RU Allocation subfield specifies the size of the RU to which it is allocated and the number of RAs that can be included in the Multi-RAA-MPDU. For example, if the value of the RU Allocation subfield is 307, the Multi-RAA-MPDU is allocated to a 484-tone RU and includes three RAs. Since the number of RAs included in the Multi-RA A-MPDU is specified, the STA decodes all data of the allocated RAs.

TABLE 10

| RU Allocation | | | | | | | | | | |
|---|---|---|---|---|---|---|---|---|---|---|
| subfield | | | | | | | | | Number | Number |
| (B8 B7 B6 B5 B4 | | | | | | | | | of | of |
| B3 B2 B1 B0) | 1 | 2 | 3 | 4 | 5 | 6 | 7 | 8 | entries | STAs |

| | | | |
|---|---|---|---|
| 304 (100110000) | 242 | 1 | 2 |
| 305 (100110001) | 242 | 1 | 3 |
| 306 (100110010) | 484 | 1 | 2 |
| 307 (100110011) | 484 | 1 | 3 |
| 308 (100110100) | 996 | 1 | 2 |
| 309 (100110101) | 966 | 1 | 3 |
| 310 (100110110) | 2x996 | 1 | 2 |
| 311 (100110111) | 2x996 | 1 | 3 |
| 312 (100111000) | MRU of pattern [gap-242]-242-484, specifically | 1 | 2 |
| | 484 + 242-tone MRU-1, 5, 9, and 13 within the | | |
| | first, second, third, and fourth 80 MHz frequency | | |
| | subblock in increasing frequency order, | | |
| | respectively | | |
| 313 (100111001) | MRU of pattern [gap-242]-242-484, specifically | 1 | 3 |
| | 484 + 242-tone MRU-1, 5, 9, and 13 within the | | |
| | first, second, third, and fourth 80 MHz frequency | | |
| | subblock in increasing frequency order. | | |
| | respectively | | |
| 314 (100111010) | MRU of pattern 242-[gap-242]-484, specifically | 1 | 2 |
| | 484 + 242-tone MRU-2, 6, 10, and 14 within the | | |
| | first, second, third, and fourth 80 MHz frequency | | |
| | subblock in increasing frequency order, | | |
| | respectively | | |
| 315 (100111011) | MRU of pattern 242-[gap-242]-484, specifically | 1 | 3 |
| | 484 + 242-tone MRU-2, 6, 10, and 14 within the | | |
| | first, second, third, and fourth 80 MHz frequency | | |
| | subblock in increasing frequency order, | | |
| | respectively | | |
| 316 (100111100) | MRU of pattern 484-[gap-242]-242, specifically | 1 | 2 |
| | 484 + 242-tone MRU-3, 7, 11, and 15 within the | | |
| | first, second, third, and fourth 80 MHz frequency | | |
| | subblock in increasing frequency order, | | |
| | respectively | | |
| 317 (100111101) | MRU of pattern 484-[gap-242]-242, specifically | 1 | 3 |
| | 484 + 242-tone MRU-3, 7, 11, and 15 within the | | |
| | first, second, third, and fourth 80 MHz frequency | | |
| | subblock in increasing frequency order, | | |
| | respectively | | |
| 318 (100111110) | MRU of pattern 484-242-[gap-242], specifically | 1 | 2 |
| | 484 + 242-tone MRU-4, 8, 12, and 16 within the | | |
| | first, second, third, and fourth 80 MHz frequency | | |
| | subblock in increasing frequency order, | | |
| | respectively | | |
| 319 (100111111) | MRU of pattern 484-242-[gap-242], specifically | 1 | 3 |
| | 484 + 242-tone MRU-4, 8, 12, and 16 within the | | |
| | first, second, third, and fourth 80 MHz frequency | | |
| | subblock in increasing frequency order, | | |
| | respectively | | |
| 320 (101000000) | MRU of pattern [gap-484]-484-996, specifically | 1 | 2 |
| | 996 + 484-tone MRU-1 and 5 within the first and | | |
| | second 160 MHz frequency subblock in | | |
| | increasing frequency order, respectively | | |
| 321 (101000001) | MRU of pattern [gap-484]-484-996, specifically | 1 | 3 |
| | 996 + 484-tone MRU-1 and 5 within the first and | | |
| | second 160 MHz frequency subblock in | | |
| | increasing frequency order, respectively | | |
| 322 (101000010) | MRU of pattern 484-[gap-484]-996, specifically | 1 | 2 |
| | 996 + 484-tone MRU-2 and 6 within the first and | | |
| | second 160 MHz frequency subblock in | | |
| | increasing frequency order, respectively | | |
| 323 (101000011) | MRU of pattern 484-[gap-484]-996, specifically | 1 | 3 |
| | 996 + 484-tone MRU-2 and 6 within the first and | | |
| | second 160 MHz frequency subblock in | | |
| | increasing frequency order, respectively | | |
| 324 (101000100) | MRU of pattern 996-[gap-484]-484, specifically | 1 | 2 |
| | 996 + 484-tone MRU-3 and 7 within the first and | | |
| | second 160 MHz frequency subblock in | | |
| | increasing frequency order, respectively | | |
| 325 (101000101) | MRU of pattern 996-[gap-484]-484, specifically | | 3 |
| | 996 + 484-tone MRU-3 and 7 within the first and | | |
| | second 160 MHz frequency subblock in | | |
| | increasing frequency order, respectively | | |
| 326 (101000110) | MRU of pattern 996-484-[gap-484], specifically | 1 | 2 |
| | 996 + 484-tone MRU-4 and 8 within the first and | | |
| | second 160 MHz frequency subblock in | | |
| | increasing frequency order, respectively | | |
| 327 (101000111) | MRU of pattern 996-484-[gap-484], specifically | 1 | 3 |
| | 996 + 484-tone MRU-4 and 8 within the first and | | |
| | second 160 MHz frequency subblock in | | |
| | increasing frequency order, respectively | | |
| 328 (101001000) | MRU of pattern [gap-996]-996-996-996, | 1 | 2 |
| | specifically 3x996-tone MRU-1 | | |
| 329 (101001001) | MRU of pattern [gap-996]-996-996-996, | 1 | 3 |
| | specifically 3x996-tone MRU-1 | | |
| 330 (101001010) | MRU of pattern 996-[gap-996]-996-996, | 1 | 2 |
| | specifically 3x996-tone MRU-2 | | |
| 331 (101001011) | MRU of pattem 996-[gap-996]-996-996, | 1 | 3 |
| | specifically 3x996-tone MRU-2 | | |
| 332 (101001100) | MRU of pattern 996-996-[gap-996]-996, | 1 | 2 |
| | specifically 3x996-tone MRU-3 | | |
| 333 (101001101) | MRU of pattem 996-996-[gap-996]-996, | 1 | 3 |
| | specifically 3x996-tone MRU-3 | | |
| 334 (101001110) | MRU of pattern 996-996-996-[gap-996], | 1 | 2 |
| | specifically 3x996-tone MRU-4 | | |
| 335 (101001111) | MRU of pattem 996-996-996-[gap-996], | 1 | 3 |
| | specifically 3x996-tone MRU-4 | | |
| 336 (101010000) | MRU of pattern [gap-484]-484-996-996-996, | 1 | 2 |
| | specifically 3x996 + 484-tone MRU-1 | | |
| 337 (101010001) | MRU of pattern [gap-484]-484-996-996-996, | 1 | 3 |
| | specifically 3x996 + 484-tone MRU-1 | | |
| 338 (101010010) | MRU of pattern 484-[gap-484]-996-996-996, | 1 | 2 |
| | specifically 3x996 + 484-tone MRU-2 | | |
| 339 (101010011) | MRU of pattern 484-[gap-484]-996-996-996, | 1 | 3 |
| | specifically 3x996 + 484-tone MRU-2 | | |
| 340 (101010100) | MRU of pattern 996-[gap-484]-484-996-996, | 1 | 2 |
| | specifically 3x996 + 484-tone MRU-3 | | |
| 341 (101010101) | MRU of pattern 996-[gap-484]-484-996-996, | 1 | 3 |
| | specifically 3x996 + 484-tone MRU-3 | | |
| 342 (101010110) | MRU of pattern 996-484-[gap-484]-996-996, | 1 | 2 |
| | specifically 3x996 + 484-tone MRU-4 | | |
| 343 (101010111) | MRU of pattern 996-484-[gap-484]-996-996, | 1 | 3 |
| | specifically 3x996 + 484-tone MRU-4 | | |
| 344 (101011000) | MRU of pattem 996-996-[gap-484]-484-996, | 1 | 2 |
| | specifically 3x996 + 484-tone MRU-5 | | |
| 345 (101011001) | MRU of pattem 996-996-[gap-484]-484-996, | 1 | 3 |
| | specifically 3x996 + 484-tone MRU-5 | | |
| 346 (101011010) | MRU of pattern 996-996-484-[gap-484]-996, | 1 | 2 |
| | specifically 3x996 + 484-tone MRU-6 | | |
| 347 (101011011) | MRU of patter 996-996-484-[gap-484]-996, | 1 | 3 |
| | specifically 3x996 + 484-tone MRU-6 | | |
| 348 (101011100) | MRU of pattern 996-996-996-[gap-484]-484, | 1 | 2 |
| | specifically 3x996 + 484-tone MRU-7 | | |
| 349 (101011101) | MRU of pattern 996-996-996-[gap-484]-484, | 1 | 3 |
| | specifically 3x996 + 484-tone MRU-7 | | |
| 350 (101011110) | MRU of pattern 996-996-996-484-[gap-484], | 1 | 2 |
| | specifically 3x996 + 484-tone MRU-8 | | |
| 351 (101011111) | MRU of pattem 996-996-996-484-[gap-484], | 1 | 3 |
| | specifically 3x996 + 484-tone MRU-8 | | |
| 352 (101100000) | MRU of pattem [gap-484]-484-996-996, | 1 | 2 |
| | specifically 2x996 + 484-tone MRU-1 and 7 within | | |
| | the 240 MHz subblock composed of the first, | | |
| | second, and third 80 MHz frequency subblock | | |
| | and the 240 MHz subblock composed of the | | |
| | second, third, and fourth 80 MHz frequency | | |
| | subblock in increasing frequency order, | | |
| | respectively | | |
| 353 (101100001) | MRU of pattern [gap-484]-484-996-996, | 1 | 3 |
| | specifically 2x996 + 484-tone MRU-1 and 7 within | | |
| | the 240 MHz subblock composed of the first, | | |
| | second, and third 80 MHz frequency subblock | | |
| | and the 240 MHz subblock composed of the | | |
| | second, third, and fourth 80 MHz frequency | | |
| | subblock in increasing frequency order, | | |
| | respectively | | |
| 354 (101100010) | MRU of pattern 484-[gap-484]-996-996, | 1 | 2 |
| | specifically 2x996 + 484-tone MRU-2 and 8 within | | |
| | the 240 MHz subblock composed of the first, | | |
| | second, and third 80 MHz frequency subblock | | |
| | and the 240 MHz subblock composed of the | | |
| | second, third, and fourth 80 MHz frequency | | |
| | subblock in increasing frequency order, | | |
| | respectively | | |
| 355 (101100011) | MRU of pattem 484-[gap-484]-996-996, | 1 | 3 |
| | specifically 2x996 + 484-tone MRU-2 and 8 within | | |
| | the 240 MHz subblock composed of the first, | | |
| | second, and third 80 MHz frequency subblock | | |
| | and the 240 MHz subblock composed of the | | |
| | second, third, and fourth 80 MHz frequency | | |
| | subblock in increasing frequency order, | | |
| | respectively | | |
| 356 (101100100) | MRU of pattern 996-[gap-484]-484-996, | 1 | 2 |
| | specifically 2x996 + 484-tone MRU-3 and 9 within | | |
| | the 240 MHz subblock composed of the first, | | |
| | second, and third 80 MHz frequency subblock | | |
| | and the 240 MHz subblock composed of the | | |
| | second, third, and fourth 80 MHz frequency | | |
| | subblock in increasing frequency order, | | |
| | respectively | | |
| 357 (101100101) | MRU of pattem 996-[gap-484]-484-996, | 1 | 3 |
| | specifically 2x996 + 484-tone MRU-3 and 9 within | | |
| | the 240 MHz subblock composed of the first, | | |
| | second, and third 80 MHz frequency subblock | | |
| | and the 240 MHz subblock composed of the | | |
| | second, third, and fourth 80 MHz frequency | | |
| | subblock in increasing frequency order, | | |
| | respectively | | |
| 358 (101100110) | MRU of pattern 996-484-[gap-484]-996, | 1 | 2 |
| | specifically 2x996 + 484-tone MRU-4 and 10 | | |
| | within the 240 MHz subblock composed of the | | |
| | first, second, and third 80 MHz frequency | | |
| | subblock and the 240 MHz subblock composed of | | |
| | the second, third, and fourth 80 MHz frequency | | |
| | subblock in increasing frequency order, | | |
| | respectively | | |
| 359 (101100111) | MRU of pattem 996-484-[gap-484]-996, | 1 | 3 |
| | specifically 2x996 + 484-tone MRU-4 and 10 | | |
| | within the 240 MHz subblock composed of the | | |
| | first, second, and third 80 MHz frequency | | |
| | subblock and the 240 MHz subblock composed of | | |
| | the second, third, and fourth 80 MHz frequency | | |
| | subblock in increasing frequency order, | | |
| | respectively | | |
| 360 (101101000) | MRU of pattern 996-996-[gap-484]-484, | 1 | 2 |
| | specifically 2x996 + 484-tone MRU-S and 11 | | |
| | within the 240 MHz subblock composed of the | | |
| | first, second, and third 80 MHz frequency | | |
| | subblock and the 240 MHz subblock composed of | | |
| | the second, third, and fourth 80 MHz frequency | | |
| | subblock in increasing frequency order, | | |
| | respectively | | |
| 361 (101101001) | MRU of pattem 996-996-[gap-484]-484, | 1 | 3 |
| | specifically 2x996 + 484-tone MRU-5 and 11 | | |
| | within the 240 MHz subblock composed of the | | |
| | first, second, and third 80 MHz frequency | | |
| | subblock and the 240 MHz subblock composed of | | |
| | the second, third, and fourth 80 MHz frequency | | |
| | subblock in increasing frequency order, | | |
| | respectively | | |
| 362 (101101010) | MRU of pattern 996-996-484-[gap-484], | 1 | 2 |
| | specifically 2x996 + 484-tone MRU-6 and 12 | | |
| | within the 240 MHz subblock composed of the | | |
| | first, second, and third 80 MHz frequency | | |
| | subblock and the 240 MHz subblock composed of | | |
| | the second, third, and fourth 80 MHz frequency | | |
| | subblock in increasing frequency order, | | |
| | respectively | | |
| 363 (101101011) | MRU of pattem 996-996-484-[gap-484], | 1 | 3 |
| | specifically 2x996 + 484-tone MRU-6 and 12 | | |
| | within the 240 MHz subblock composed of the | | |
| | first, second, and third 80 MHz frequency | | |
| | subblock and the 240 MHz subblock composed of | | |
| | the second, third, and fourth 80 MHz frequency | | |
| | subblock in increasing frequency order, | | |
| | respectively | | |

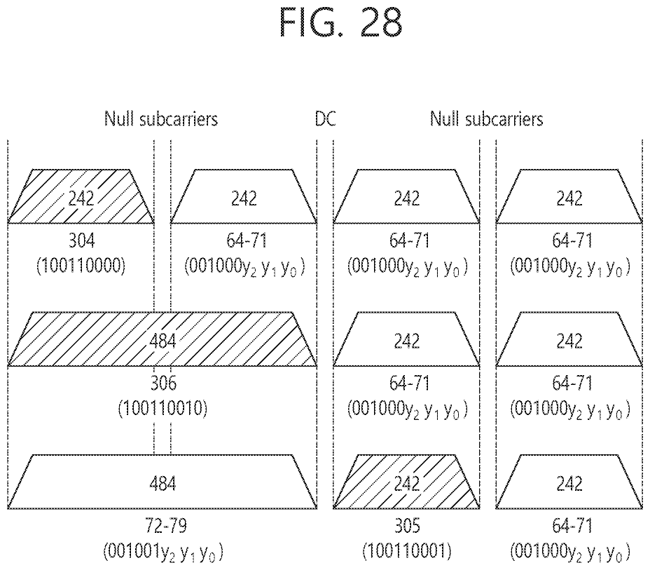

FIG. 28 illustrates an example tone plan with allocated RUs for transmission of a Multi-RA A-MPDU in an 80 MHz bandwidth.

FIG. 28 shows an example of an MRU plan and a tone plan used to transmit a Multi-RA A-MPDU based on the value of the RU Allocation subfield in an 80 MHz bandwidth. The RUs used for the Multi-RA A-MPDU are shaded.

For the first 242-tone RU (shaded) in the four 242-tone RUs in the first row of FIG. 28, the value of the RU Allocation subfield is set to 304 (100110000), so that a Multi-RA A-MPDU including two RAs can be transmitted in that RU. For the second to fourth 242-tone RUs (not shaded), the value of each RU Allocation subfield has one of the values 61 to 71, so that an A-MPDU with one RA using MU-MIMO can be transmitted in that RU.

In the second row of FIG. 28, for the first 484-tone RU (shaded), the value of the RU Allocation subfield is set to 306 (100110010), so that a Multi-RA A-MPDU with two RAs can be transmitted in that RU. Similarly, for the second and third 242-tone RUs (not shaded), the value of each RU Allocation subfield is one of the values 61 to 71, so that an A-MPDU with one RA using MU-MIMO can be transmitted in that RU.

In the third row of FIG. 28, among one 484-tone RU and two 242-tone RUs, the value of the RU Allocation subfield is set to 305 (100110001) for the second positioned 242-tone RU (indicated by the shaded area), so that a Multi-RA A-MPDU with three RAs can be transmitted in that RU. For the first positioned 484-tone RU, the value of the RU Allocation subfield is one of the values from 72 to 79, so that an A-MPDU with one RA using MU-MIMO can be transmitted in that RU. For the third positioned 242-tone RU, the value of the RU Allocation subfield is one of the values from 61 to 71, so that an A-MPDU with one RA using MU-MIMO can be transmitted in that RU.

In the second and third lines of FIG. 28, the RUs other than the RUs that send Multi-RA A-MPDUs, including one 484-tone RU and two 242-tone RUs, are all RUs that use MU-MIMO. In this specification, only the single user case, not MU-MIMO, is considered for Multi-RA A-MPDUs, and examples of the values of the corresponding bits are indicated, but the pattern is not always limited to that pattern.

Normally, when an STA receives an A-MPDU, the STA checks the header of the A-MPDU to determine the RA and AID, and if it is an A-MPDU addressed to it, it does not decode it (skip). When an STA receives a Multi-RA A-MPDU, if the first A-MPDU subframe does not have its own RA, it may not be able to read the A-MPDU subframe transmitted to it later even if there is one. Therefore, if the value of the RU Allocation subfield is set to Multi-RA A-MPDU, all STAs assigned to the corresponding RU decode the Multi-RA A-MPDU until the end (up to the last A-MPDU subframe of the Multi-RAA-MPDU) through PHY signaling (RXVECTOR).

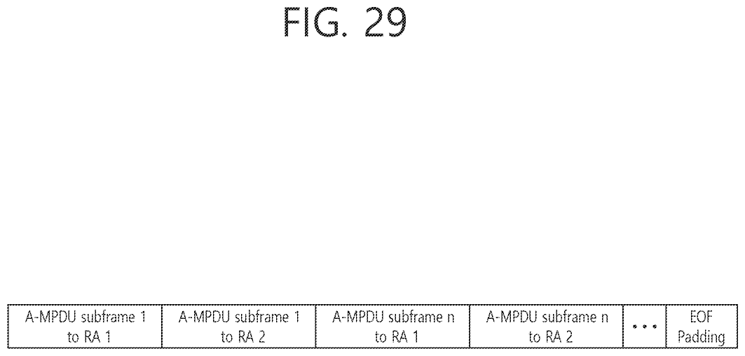

FIG. 29 illustrates an example of the arrangement of A-MPDU subframes within a Multi-RA A-MPDU.

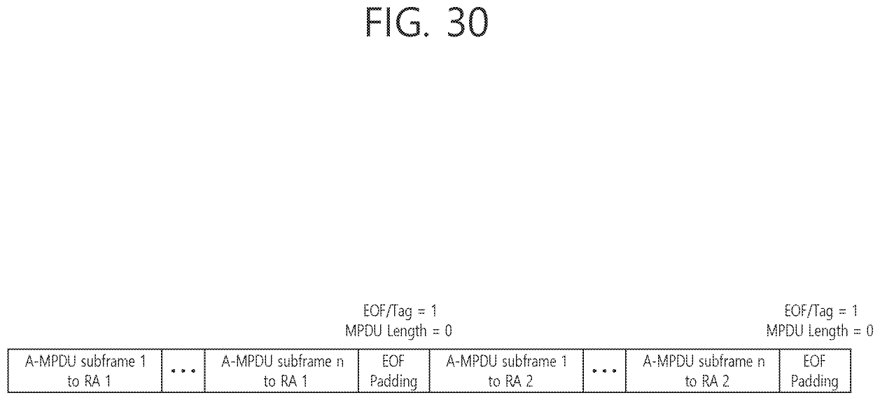

FIG. 30 illustrates an example of the arrangement of A-MPDU subframes within a Multi-RA A-MPDU to reduce frame decoding time.

Multi-RA A-MPDUs are not limited to arranging multiple A-MPDU subframes in a row according to RA as shown in FIG. 29, but can be sporadically configured. FIG. 29 shows an example of a Multi-RA A-MPDU in which subframes are arranged regularly according to RA, but may not be organized regularly. The order of subframes may be the order in which they must be sent quickly or the order that considers fairness, but the order is not limited. Unlike the method as shown in FIG. 29, a Multi-RA A-MPDU can be configured as shown in FIG. 30 to reduce the time consumed by all STAs receiving the Multi-RAA-MPDU to decode A-MPDU subframes that they do not receive. In FIG. 30, A-MPDU subframes with the same RA are arranged in a row, and EOF Padding is added to the end of the last subframe among the A-MPDU subframes sent to a specific RA to set EOF/Tag=1, MPDU Length=0. When reading a Multi-RA A-MPDU, an STA can reduce decoding time by performing decoding up to the EOF Padding part if the RA of a subframe is the same as its own RA and not reading the part afterward. In addition, the STA does not decode subframes that do not have its own RA, but reads up to the EOF Padding part and then checks the RA of the following subframe to determine whether the subframe is addressed to it. By placing EOF Padding between subframes with different RAs in this way, the STA can avoid decoding the entire subframe that does not correspond to it, reducing unnecessary time.

For example, in FIG. 29, STA1 and STA2 must decode all A-MPDU subframes 1-n for RA1 and RA2.

However, in FIG. 30, STA1 may decode A-MPDU subframe 1-n for RAL, decode EOP Padding, and then not decode A-MPDU subframe 1-n for RA2. STA2 may skip decoding A-MPDU subframe 1-n for RAL and decode EOP Padding in the middle before decoding A-MPDU subframe 1-n for RA2. This has the effect of reducing the time that STAs spend decoding Multi-RA A-MPDUs.

Conventional EOF padding was deployed to indicate the end (final) of an A-MPDU, but in Multi-RA A-MPDU, it is used to indicate the end of a subframe with a specific RA. Therefore, if an STA decodes EOF padding equal to the number of STAs included in the Multi-RAA-MPDU, the STA can determine the end of the Multi-RA A-MPDU.

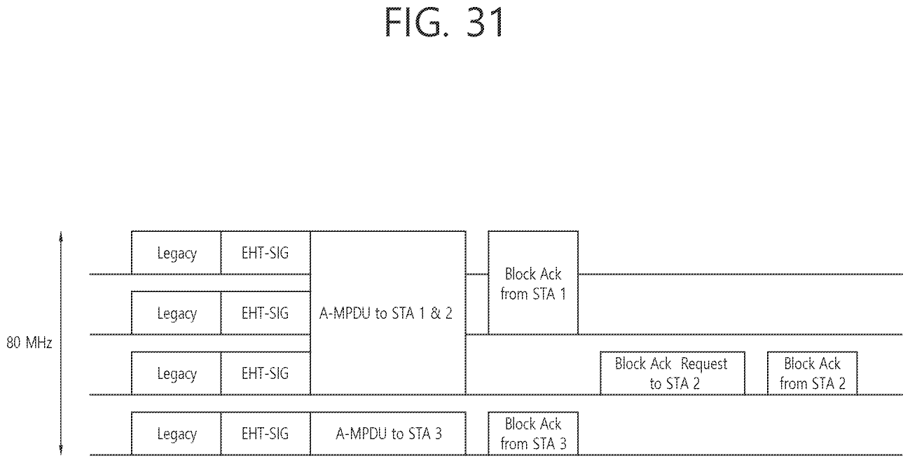

FIG. 31 illustrates an example of receiving a Block ACK through the transmission of a Block ACK Request frame.

The method by which an AP receives an Acknowledgment after transmitting an A-MPDU is described as follows. In other words, the method by which an STA transmits an Ack for a Multi-RA A-MPDU proposed in this specification can operate in one or more of the methods listed below.

The first method, as shown in FIG. 17, is to receive Block ACKs from all STAs simultaneously. When performing RU allocation in advance, RUs for Block ACKs are allocated to all STAs receiving A-MPDUs and the ACK policy is set to Implicit BAR (Block Ack Request). In the case of Multi-RA A-MPDUs, the AP also allocates RUs for Block Acks to all STAs included in the RA.

The second method is to separately receive Block Acks by transmitting a Block Ack Request frame only to STAs receiving Low-latency traffic frames, as shown in FIG. 31. First, other STAs (STA 1 and STA 3) set the Ack policy to Implicit BAR so that they can receive Block ACKs immediately after transmitting A-MPDUs, and then STAs sending Low-latency traffic (STA 2) set the Ack policy to Block Ack so that they receive Block Acks separately.

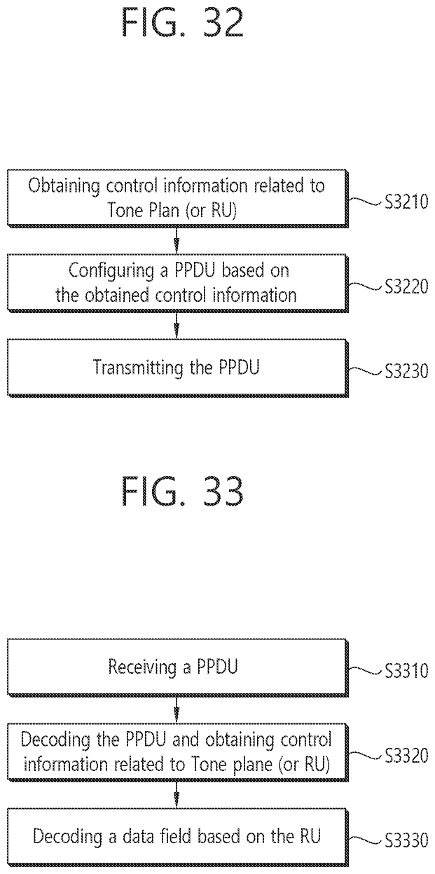

FIG. 32 is a flowchart illustrating the operation of a transmitting device according to the present embodiment.

The example of FIG. 32 may be performed by a transmitting device (AP and/or non-AP STA).

Some of each step (or detailed sub-step to be described later) of the example of FIG. 32 may be skipped/omitted.

Through step S3210, the transmitting device (transmitting STA) may obtain information about the above-described tone plan. As described above, the information about the tone plan includes the size and location of the RU, control information related to the RU, information about a frequency band including the RU, information about an STA receiving the RU, and the like.

Through step S3220, the transmitting device may construct/generate a PPDU based on the acquired control information. Configuring/generating the PPDU may include configuring/generating each field of the PPDU. That is, step S3220 includes configuring the EHT-SIG field including control information about the tone plan. That is, step S3220 includes configuring a field including control information (e.g., N bitmap) indicating the size/position of the RU; and/or configuring a field including an identifier of an STA receiving the RU (e.g., AID).

Also, step S3220 may include generating an STF/LTF sequence transmitted through a specific RU. The STF/LTF sequence may be generated based on a preset STF generation sequence/LTF generation sequence.

Also, step S3220 may include generating a data field (i.e., MPDU) transmitted through a specific RU.

The transmitting device may transmit the PPDU constructed through step S3220 to the receiving device based on step S3230.

While performing step S3230, the transmitting device may perform at least one of operations such as CSD, Spatial Mapping, IDFT/IFFT operation, and GI insertion.

A signal/field/sequence constructed according to the present specification may be transmitted in the form of FIG. 5.

FIG. 33 is a flowchart illustrating the operation of the receiving apparatus/device according to the present embodiment.

The aforementioned PPDU may be received according to the example of FIG. 33.

The example of FIG. 33 may be performed by a receiving apparatus/device (AP and/or non-AP STA).

Some of each step (or detailed sub-step to be described later) of the example of FIG. 33 may be skipped/omitted.

The receiving device (receiving STA) may receive all or part of the PPDU through step S3310. The received signal may be in the form of FIG. 5.

A sub-step of step S3310 may be determined based on step S3230 of FIG. 32. That is, in step S3310, an operation of restoring the result of the CSD, Spatial Mapping, IDFT/IFFT operation, and GI insertion operation applied in step S3230 may be performed.

In step S3320, the receiving device may perform decoding on all/part of the PPDU. Also, the receiving device may obtain control information related to a tone plan (i.e., RU) from the decoded PPDU.

More specifically, the receiving device may decode the L-SIG and EHT-SIG of the PPDU based on the legacy STF/LTF and obtain information included in the L-SIG and EHT SIG fields. Information on various tone plans (i.e., RUs) described in this specification may be included in the EHT-SIG, and the receiving STA may obtain information on the tone plan (i.e., RU) through the EHT-SIG.

In step S3330, the receiving device may decode the remaining part of the PPDU based on information about the tone plan (i.e., RU) acquired through step S3320. For example, the receiving STA may decode the STF/LTF field of the PPDU based on information about one plan (i.e., RU). In addition, the receiving STA may decode the data field of the PPDU based on information about the tone plan (i.e., RU) and obtain the MPDU included in the data field.

In addition, the receiving device may perform a processing operation of transferring the data decoded through step S3330 to a higher layer (e.g., MAC layer). In addition, when generation of a signal is instructed from the upper layer to the PHY layer in response to data transmitted to the upper layer, a subsequent operation may be performed.

Hereinafter, the above-described embodiment will be described with reference to FIG. 1 to FIG. 33.

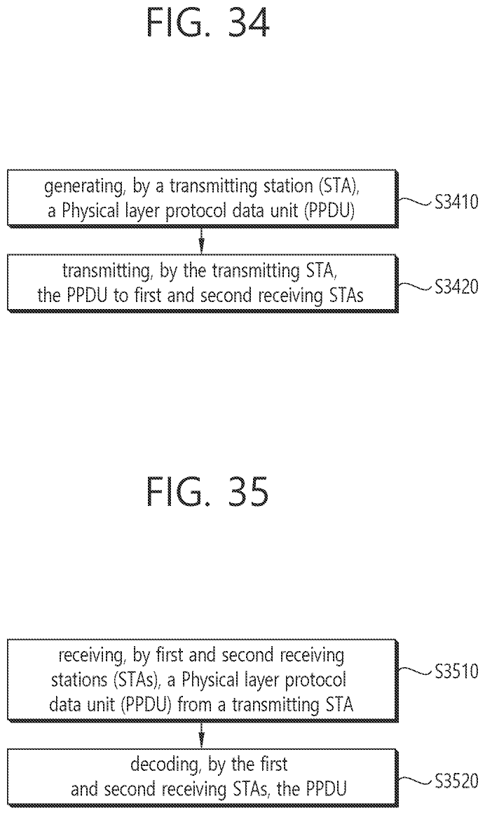

FIG. 34 is a flowchart illustrating a procedure for transmitting a multi-RA A-MPDU according to the present embodiment.

The example of FIG. 34 may be performed in a network environment that supports a next-generation wireless LAN system (Ultra High Reliability (UHR) wireless LAN system or next Wi-Fi). The next-generation wireless LAN system is an improved version of the 802.11be system and can satisfy backward compatibility with the 802.11be system.

The example of FIG. 34 is performed at a transmitting STA, which may correspond to an access point (AP). The receiving STA of FIG. 34 may correspond to at least one STA (station).

This embodiment proposes a method for configuring a Multi-RAA-MPDU that can be transmitted to two or more STAs with one A-MPDU to solve low latency traffic. In particular, the present embodiment proposes a method for configuring the number of RAs that can be included in the Multi-RA A-MPDU and a size of the RU to which the Multi-RA A-MPDU is allocated based on a RU allocation subfield of a signal field.

In step S3410, a transmitting station (STA) generates a Physical layer protocol data unit (PPDU).

In step S3420, the transmitting STA transmits the PPDU to first and second receiving STAs.

The PPDU includes a signal field and a first Aggregate-MAC protocol data unit (A-MPDU).

The signal field includes a first Resource Unit (RU) allocation subfield. The first RU allocation subfield includes information on a number of Receiver Addresses (RAs) set in the first A-MPDU and a size of a RU or Multiple Resource Unit (MRU) to which the first A-MPDU is allocated.

The RAs set in the first A-MPDU include a first RA for the first receiving STA and a second RA for the second receiving STA.

The PPDU may further include a second A-MPDU.

The signal field may further include a second RU allocation subfield. The second RU allocation subfield may include information on a size of a RU or MRU to which the second A-MPDU is allocated.

A RA set in the second A-MPDU may only include a third RA for a third receiving STA.

Here, the first A-MPDU may correspond to a Multi-RA A-MPDU that has two (or more than two) RAs and can be transmitted to two (or more than two) STAs. The second A-MPDU may correspond to a conventional A-MPDU that has only one RA and can be transmitted to only one STA. That is, the first A-MPDU may be transmitted to the first and second receiving STAs, and the second A-MPDU may be transmitted to the third receiving STA.

That is, the present embodiment proposes a method of configuring a Multi-RA A-MPDU that can transmit one A-MPDU to two or more STAs by including two or more RAs in one A-MPDU in order to transmit low latency traffic more quickly. In particular, by newly defining a Disregarded value of the RU allocation subfield, the number of RAs set in a Multi-RA A-MPDU and the size of the allocated RU or MRU can be known, so that the AP can effectively preemptively transmit (transmit with priority) low latency traffic. This has the effect of reducing latency more efficiently by supporting differentiated transmission for STAs with different QoS by utilizing A-MPDU, which is an important transmission technology of Wi-Fi.

The signal field may further include a Station Identifier (STA ID) subfield. The STA ID subfield includes IDs of the first to third receiving STAs. At this time, the MAC layer may distinguish and indicate whether the first and second A-MPDUs are existing A-MPDUs or Multi-RA A-MPDUs.

The signal field may include a common field and a user field. The common field may include the first and second RU allocation subfields. The user field may include the STA ID subfield. The signal field may be an EHT-SIG or a UHR-SIG.

A method of configuring the first A-MPDU (Multi-RA A-MPDU) as the first RU allocation subfield and configuring the second A-MPDU (existing A-MPDU) as the second RU allocation subfield is as follows.

Based on a bandwidth of the PPDU being 80 MHz and the 80 MHz including first to fourth 242-tone RUs, an example of configuring the first and second RU allocation subfields is as follows.

For the first 242-tone RU, based on a value of the first RU allocation subfield being 304, the number of RAs set in the first A-MPDU may be 2, and the RU or MRU to which the first A-MPDU is allocated may be the first 242-tone RU (see Table 10 above).

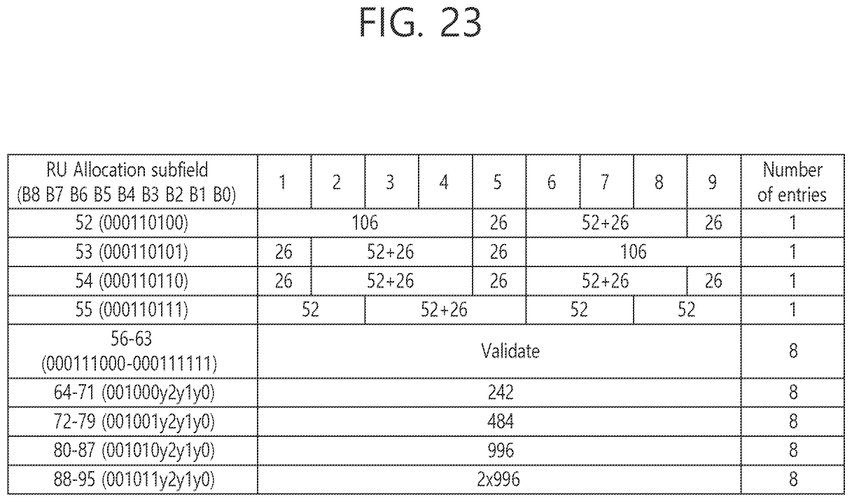

For the second to fourth 242-tone RUs, based on a value of the second RU allocation subfield being one of 61 to 71, the number of RAs set in the second A-MPDU may be 1, and the RU or MRU to which the second A-MPDU is allocated may be the second to fourth 242-tone RUs using Multi User-Multi Input Multi Output (MU-MIMO) (see FIG. 23).

Based on a bandwidth of the PPDU being 80 MHz and the 80 MHz including a first 484-tone RU and first and second 242-tone RUs, an example of configuring the first and second RU allocation subfields is as follows.

For the first 484-tone RU, based on a value of the first RU allocation subfield being 306, the number of RAs set in the first A-MPDU may be 2, and the RU or MRU to which the first A-MPDU is allocated may be the first 484-tone RU (see Table 10 above).

For the first and second 242-tone RUs, based on a value of the second RU allocation subfield being one of 61 to 71, the number of RAs set in the second A-MPDU may be 1, and the RU or MRU to which the second A-MPDU is allocated may be the first and second 242-tone RUs using MU-MIMO (see FIG. 23).

Based on a bandwidth of the PPDU being 80 MHz and the 80 MHz including a first 484-tone RU and first and second 242-tone RUs, an example of configuring the first and second RU allocation subfields is as follows.

For the first 242-tone RU, based on a value of the first RU allocation subfield being 305, the number of RAs set in the first A-MPDU may be 3, and the RU or MRU to which the first A-MPDU may be allocated is the first 242-tone RU (see Table 10 above).

For the first 484-tone RU, based on a value of the second RU allocation subfield being one of 72 to 79, the number of RAs set in the second A-MPDU may be 1, and the RU or MRU to which the second A-MPDU is allocated may be the first 484-tone RU using MU-MIMO (see FIG. 23).

For the second 242-tone RU, based on a value of the second RU allocation subfield being one of 61 to 71, the number of RAs set in the second A-MPDU may be 1, and the RU or MRU to which the second A-MPDU is allocated may be the second 242-tone RU using MU-MIMO (see FIG. 23).

Based on the number of RAs set in the first A-MPDU being 3, the RA set in the first A-MPDU may further include a fourth RA for a fourth receiving STA. The first A-MPDU may be transmitted to the first, second, and fourth receiving STAs.

As another example, based on a value of the first RU allocation subfield being 312, the number of RAs set in the first A-MPDU may be 2, and the RU or MRU to which the first A-MPDU is allocated may be a 484+242-tone MRU (wherein, the pattern of the 484+242-tone MRU is [gap-242]-242-484) within the first, second, third, and fourth 80 MHz frequency subblocks (see Table 10 above).

As another example, based on a value of the first RU allocation subfield being 363, the number of RAs set in the first A-MPDU may be 3, and the RU or MRU to which the first A-MPDU is allocated may be

a 2×996+484-tone MRU within a 240 MHz subblock composed of the first, second, and third 80 MHz frequency subblocks and a 2×996+484-tone MRU within a 240 MHz subblock composed of the second, third, and fourth 80 MHz frequency subblocks (wherein, the pattern of the 2×996+484-tone MRU is 996-996-484-[gap-484]) (see Table 10 above).

The first A-MPDU sequentially may include a plurality of A-MPDU subframes for the first RA, a first End Of Frame (EOF) Padding, a plurality of A-MPDU subframes for the second RA, and a second EOF Padding. The first and second EOF Padding may have EOF/Tag set to 1 and MPDU Length set to 0.

The first EOF Padding may include information indicating that the plurality of A-MPDU subframes for the first RA have ended. The first receiving STA may decode the first EOF Padding and know that decoding of the A-MPDU subframes for its RA is complete, and may not decode the plurality of A-MPDU subframes for the second RA that follow.

The second EOF Padding may include information indicating that the plurality of A-MPDU subframes for the second RA have ended. The second receiving STA may skip decoding the plurality of A-MPDU subframes for the first RA and decode the first EOF Padding (after confirming its own RA) to decode the plurality of A-MPDU subframes for the second RA that follow.

This has the effect of reducing unnecessary time in the decoding process by eliminating the need for the receiving STA to decode subframes that are not set for it (i.e., by eliminating the need to decode multiple subframes entirely).

The second receiving STA may receive a Block Ack request frame from the transmitting STA. The second receiving STA may transmit a Block Ack for the first A-MPDU based on the Block Ack request frame. If the second receiving STA is an STA receiving low latency traffic, the transmitting STA may transmit a Block Ack request frame so that the second receiving STA may separately receive the Block Ack.

FIG. 35 is a flowchart illustrating a procedure for receiving a multi-RA A-MPDU according to the present embodiment.

The example of FIG. 35 may be performed in a network environment that supports a next-generation wireless LAN system (Ultra High Reliability (UHR) wireless LAN system or next Wi-Fi). The next-generation wireless LAN system is an improved version of the 802.11be system and can satisfy backward compatibility with the 802.11be system.

The example of FIG. 35 is performed at a receiving STA, which may correspond to at least one station (STA). The transmitting STA of FIG. 35 may correspond to an access point (AP).

This embodiment proposes a method for configuring a Multi-RA A-MPDU that can be transmitted to two or more STAs with one A-MPDU to solve low latency traffic. In particular, the present embodiment proposes a method for configuring the number of RAs that can be included in the Multi-RA A-MPDU and a size of the RU to which the Multi-RA A-MPDU is allocated based on a RU allocation subfield of a signal field.

In step S3510, first and second receiving stations (STAs) receive a Physical Layer Protocol Data Unit (PPDU) from a transmitting STA.

In step S3520, the first and second receiving STAs decode the PPDU.

The PPDU includes a signal field and a first Aggregate-MAC protocol data unit MPDU).

The signal field includes a first Resource Unit (RU) allocation subfield. The first RU allocation subfield includes information on a number of Receiver Addresses (RAs) set in the first A-MPDU and a size of a RU or Multiple Resource Unit (MRU) to which the first A-MPDU is allocated.

The RAs set in the first A-MPDU include a first RA for the first receiving STA and a second RA for the second receiving STA.

The PPDU may further include a second A-MPDU.

The signal field may further include a second RU allocation subfield. The second RU allocation subfield may include information on a size of a RU or MRU to which the second A-MPDU is allocated.

A RA set in the second A-MPDU may only include a third RA for a third receiving STA.

Here, the first A-MPDU may correspond to a Multi-RA A-MPDU that has two (or more than two) RAs and can be transmitted to two (or more than two) STAs. The second A-MPDU may correspond to a conventional A-MPDU that has only one RA and can be transmitted to only one STA. That is, the first A-MPDU may be transmitted to the first and second receiving STAs, and the second A-MPDU may be transmitted to the third receiving STA.

That is, the present embodiment proposes a method of configuring a Multi-RA A-MPDU that can transmit one A-MPDU to two or more STAs by including two or more RAs in one A-MPDU in order to transmit low latency traffic more quickly. In particular, by newly defining a Disregarded value of the RU allocation subfield, the number of RAs set in a Multi-RA A-MPDU and the size of the allocated RU or MRU can be known, so that the AP can effectively preemptively transmit (transmit with priority) low latency traffic. This has the effect of reducing latency more efficiently by supporting differentiated transmission for STAs with different QoS by utilizing A-MPDU, which is an important transmission technology of Wi-Fi.

The signal field may further include a Station Identifier (STA ID) subfield. The STA ID subfield includes IDs of the first to third receiving STAs. At this time, the MAC layer may distinguish and indicate whether the first and second A-MPDUs are existing A-MPDUs or Multi-RA A-MPDUs.

The signal field may include a common field and a user field. The common field may include the first and second RU allocation subfields. The user field may include the STA ID subfield. The signal field may be an EHT-SIG or a UHR-SIG.

A method of configuring the first A-MPDU (Multi-RA A-MPDU) as the first RU allocation subfield and configuring the second A-MPDU (existing A-MPDU) as the second RU allocation subfield is as follows.

Based on a bandwidth of the PPDU being 80 MHz and the 80 MHz including first to fourth 242-tone RUs, an example of configuring the first and second RU allocation subfields is as follows.

For the first 242-tone RU, based on a value of the first RU allocation subfield being 304, the number of RAs set in the first A-MPDU may be 2, and the RU or MRU to which the first A-MPDU is allocated may be the first 242-tone RU (see Table 10 above).

For the second to fourth 242-tone RUs, based on a value of the second RU allocation subfield being one of 61 to 71, the number of RAs set in the second A-MPDU may be 1, and the RU or MRU to which the second A-MPDU is allocated may be the second to fourth 242-tone RUs using Multi User-Multi Input Multi Output (MU-MIMO) (see FIG. 23).

Based on a bandwidth of the PPDU being 80 MHz and the 80 MHz including a first 484-tone RU and first and second 242-tone RUs, an example of configuring the first and second RU allocation subfields is as follows.

For the first 484-tone RU, based on a value of the first RU allocation subfield being 306, the number of RAs set in the first A-MPDU may be 2, and the RU or MRU to which the first A-MPDU is allocated may be the first 484-tone RU (see Table 10 above).

For the first and second 242-tone RUs, based on a value of the second RU allocation subfield being one of 61 to 71, the number of RAs set in the second A-MPDU may be 1, and the RU or MRU to which the second A-MPDU is allocated may be the first and second 242-tone RUs using MU-MIMO (see FIG. 23).

Based on a bandwidth of the PPDU being 80 MHz and the 80 MHz including a first 484-tone RU and first and second 242-tone RUs, an example of configuring the first and second RU allocation subfields is as follows.

For the first 242-tone RU, based on a value of the first RU allocation subfield being 305, the number of RAs set in the first A-MPDU may be 3, and the RU or MRU to which the first A-MPDU may be allocated is the first 242-tone RU (see Table 10 above).

For the first 484-tone RU, based on a value of the second RU allocation subfield being one of 72 to 79, the number of RAs set in the second A-MPDU may be 1, and the RU or MRU to which the second A-MPDU is allocated may be the first 484-tone RU using MU-MIMO (see FIG. 23).

For the second 242-tone RU, based on a value of the second RU allocation subfield being one of 61 to 71, the number of RAs set in the second A-MPDU may be 1, and the RU or MRU to which the second A-MPDU is allocated may be the second 242-tone RU using MU-MIMO (see FIG. 23).

Based on the number of RAs set in the first A-MPDU being 3, the RA set in the first A-MPDU may further include a fourth RA for a fourth receiving STA. The first A-MPDU may be transmitted to the first, second, and fourth receiving STAs.

As another example, based on a value of the first RU allocation subfield being 312, the number of RAs set in the first A-MPDU may be 2, and the RU or MRU to which the first A-MPDU is allocated may be a 484+242-tone MRU (wherein, the pattern of the 484+242-tone MRU is [gap-242]-242-484) within the first, second, third, and fourth 80 MHz frequency subblocks (see Table 10 above).

As another example, based on a value of the first RU allocation subfield being 363, the number of RAs set in the first A-MPDU may be 3, and the RU or MRU to which the first A-MPDU is allocated may be

a 2×996+484-tone MRU within a 240 MHz subblock composed of the first, second, and third 80 MHz frequency subblocks and a 2×996+484-tone MRU within a 240 MHz subblock composed of the second, third, and fourth 80 MHz frequency subblocks (wherein, the pattern of the 2×996+484-tone MRU is 996-996-484-[gap-484]) (see Table 10 above).

The first A-MPDU sequentially may include a plurality of A-MPDU subframes for the first RA, a first End Of Frame (EOF) Padding, a plurality of A-MPDU subframes for the second RA, and a second EOF Padding. The first and second EOF Padding may have BOF/Tag set to 1 and MPDU Length set to 0.

The first BOF Padding may include information indicating that the plurality of A-MPDU subframes for the first RA have ended. The first receiving STA may decode the first EOF Padding and know that decoding of the A-MPDU subframes for its RA is complete, and may not decode the plurality of A-MPDU subframes for the second RA that follow.

The second EOF Padding may include information indicating that the plurality of A-MPDU subframes for the second RA have ended. The second receiving STA may skip decoding the plurality of A-MPDU subframes for the first RA and decode the first EOF Padding (after confirming its own RA) to decode the plurality of A-MPDU subframes for the second RA that follow.

This has the effect of reducing unnecessary time in the decoding process by eliminating the need for the receiving STA to decode subframes that are not set for it (i.e., by eliminating the need to decode multiple subframes entirely).

The second receiving STA may receive a Block Ack request frame from the transmitting STA. The second receiving STA may transmit a Block Ack for the first A-MPDU based on the Block Ack request frame. If the second receiving STA is an STA receiving low latency traffic, the transmitting STA may transmit a Block Ack request frame so that the second receiving STA may separately receive the Block Ack.

### <Device Configuration>

The technical features of the present disclosure may be applied to various devices and methods. For example, the technical features of the present disclosure may be performed/supported through the device(s) of FIG. 1 and/or FIG. 14. For example, the technical features of the present disclosure may be applied to only part of FIG. 1 and/or FIG. 14. For example, the technical features of the present disclosure may be implemented based on the processing chip(s) 114 and 124 of FIG. 1, or implemented based on the processor(s) 111 and 121 and the memory(s) 112 and 122, or implemented based on the processor 610 and the memory 620 of FIG. 14. For example, the device according to the present disclosure receives a Physical layer protocol data unit (PPDU) from a transmitting station (STA); and decodes the PPDU.

The technical features of the present disclosure may be implemented based on a computer readable medium (CRM). For example, a CRM according to the present disclosure is at least one computer readable medium including instructions designed to be executed by at least one processor.

The CRM may store instructions that perform operations including receiving a Physical layer protocol data unit (PPDU) from a transmitting station (STA); and decoding the PPDU. At least one processor may execute the instructions stored in the CRM according to the present disclosure. At least one processor related to the CRM of the present disclosure may be the processor 111, 121 of FIG. 1, the processing chip 114, 124 of FIG. 1, or the processor 610 of FIG. 14. Meanwhile, the CRM of the present disclosure may be the memory 112, 122 of FIG. 1, the memory 620 of FIG. 14, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method in a wireless local area network (WLAN) system, the method comprising:
receiving, by first and second receiving stations (STAs), a Physical layer protocol data unit (PPDU) from a transmitting STA; and
decoding, by the first and second receiving STAs, the PPDU,
wherein the PPDU includes a signal field and a first Aggregate-MAC protocol data unit (A-MPDU),
wherein the signal field includes a first Resource Unit (RU) allocation subfield,
wherein the first RU allocation subfield includes information on a number of Receiver Addresses (RAs) set in the first A-MPDU and a size of a RU or Multiple Resource Unit (MRU) to which the first A-MPDU is allocated, and
wherein the RAs set in the first A-MPDU include a first RA for the first receiving STA and a second RA for the second receiving STA.

2. The method of claim 1, wherein the PPDU further includes a second A-MPDU,
wherein the signal field further includes a second RU allocation subfield,
wherein the second RU allocation subfield includes information on a size of a RU or MRU to which the second A-MPDU is allocated, and
wherein a RA set in the second A-MPDU only includes a third RA for a third receiving STA.

3. The method of claim 2, wherein the first A-MPDU is transmitted to the first and second receiving STAs,
wherein the second A-MPDU is transmitted to the third receiving STA.

4. The method of claim 2, wherein the signal field further includes a Station Identifier (STA ID) subfield,
wherein the STA ID subfield includes IDs of the first to third receiving STAs.

5. The method of claim 2, wherein based on a bandwidth of the PPDU being 80 MHz and the 80 MHz including first to fourth 242-tone RUs,
wherein, for the first 242-tone RU, based on a value of the first RU allocation subfield being 304, the number of RAs set in the first A-MPDU is 2, and the RU or MRU to which the first A-MPDU is allocated is the first 242-tone RU,
wherein, for the second to fourth 242-tone RUs, based on a value of the second RU allocation subfield being one of 61 to 71, the number of RAs set in the second A-MPDU is 1, and the RU or MRU to which the second A-MPDU is allocated is the second to fourth 242-tone RUs using Multi User-Multi Input Multi Output (MU-MIMO).

6. The method of claim 2, wherein based on a bandwidth of the PPDU being 80 MHz and the 80 MHz including a first 484-tone RU and first and second 242-tone RUs,
wherein, for the first 484-tone RU, based on a value of the first RU allocation subfield being 306, the number of RAs set in the first A-MPDU is 2, and the RU or MRU to which the first A-MPDU is allocated is the first 484-tone RU,
wherein, for the first and second 242-tone RUs, based on a value of the second RU allocation subfield being one of 61 to 71, the number of RAs set in the second A-MPDU is 1, and the RU or MRU to which the second A-MPDU is allocated is the first and second 242-tone RUs using MU-MIMO.

7. The method of claim 2, wherein based on a bandwidth of the PPDU being 80 MHz and the 80 MHz including a first 484-tone RU and first and second 242-tone RUs,
wherein, for the first 242-tone RU, based on a value of the first RU allocation subfield being 305, the number of RAs set in the first A-MPDU is 3, and the RU or MRU to which the first A-MPDU is allocated is the first 242-tone RU,
wherein, for the first 484-tone RU, based on a value of the second RU allocation subfield being one of 72 to 79, the number of RAs set in the second A-MPDU is 1, and the RU or MRU to which the second A-MPDU is allocated is the first 484-tone RU using MU-MIMO,
wherein, for the second 242-tone RU, based on a value of the second RU allocation subfield being one of 61 to 71, the number of RAs set in the second A-MPDU is 1, and the RU or MRU to which the second A-MPDU is allocated is the second 242-tone RU using MU-MIMO.

8. The method of claim 7, wherein based on the number of RAs set in the first A-MPDU being 3, the RA set in the first A-MPDU further includes a fourth RA for a fourth receiving STA,
wherein the first A-MPDU is transmitted to the first, second, and fourth receiving STAs.

9. The method of claim 1, wherein the first A-MPDU sequentially includes a plurality of A-MPDU subframes for the first RA, a first End Of Frame (EOF) Padding, a plurality of A-MPDU subframes for the second RA, and a second EOF Padding,
wherein the first EOF Padding includes information indicating that the plurality of A-MPDU subframes for the first RA have ended,
wherein the second EOF Padding includes information indicating that the plurality of A-MPDU subframes for the second RA have ended.

10. The method of claim 1, further comprising:
receiving, by the second receiving STA, a Block Ack request frame from the transmitting STA;
transmitting, by the second receiving STA, a Block Ack for the first A-MPDU based on the Block Ack request frame.

11. A first and second receiving stations (STAs) in a wireless local area network (WLAN) system, the first and second receiving STAs comprising:
a memory;
a transceiver; and
a processor being operatively connected to the memory and the transceiver,
wherein the processor is configured to:
receive a Physical layer protocol data unit (PPDU) from a transmitting STA; and
decode the PPDU,
wherein the PPDU includes a signal field and a first Aggregate-MAC protocol data unit (A-MPDU),
wherein the signal field includes a first Resource Unit (RU) allocation subfield,
wherein the first RU allocation subfield includes information on a number of Receiver Addresses (RAs) set in the first A-MPDU and a size of a RU or Multiple Resource Unit (MRU) to which the first A-MPDU is allocated, and
wherein the RAs set in the first A-MPDU include a first RA for the first receiving STA and a second RA for the second receiving STA.

12. A method in a wireless local area network (WLAN) system, the method comprising:
generating, by a transmitting station (STA), a Physical layer protocol data unit (PPDU); and
transmitting, by the transmitting STA, the PPDU to first and second receiving STAs,
wherein the PPDU includes a signal field and a first Aggregate-MAC protocol data unit (A-MPDU),
wherein the signal field includes a first Resource Unit (RU) allocation subfield,
wherein the first RU allocation subfield includes information on a number of Receiver Addresses (RAs) set in the first A-MPDU and a size of a RU or Multiple Resource Unit (MRU) to which the first A-MPDU is allocated, and
wherein the RAs set in the first A-MPDU include a first RA for the first receiving STA and a second RA for the second receiving STA.

13. The method of claim 12, wherein the PPDU further includes a second A-MPDU,
wherein the signal field further includes a second RU allocation subfield,
wherein the second RU allocation subfield includes information on a size of a RU or MRU to which the second A-MPDU is allocated, and
wherein a RA set in the second A-MPDU only includes a third RA for a third receiving STA.

14. The method of claim 13, wherein the first A-MPDU is transmitted to the first and second receiving STAs,
wherein the second A-MPDU is transmitted to the third receiving STA.

15. The method of claim 13, wherein the signal field further includes a Station Identifier (STA ID) subfield,
wherein the STA ID subfield includes IDs of the first to third receiving STAs.

16. The method of claim 13, wherein based on a bandwidth of the PPDU being 80 MHz and the 80 MHz including first to fourth 242-tone RUs,
wherein, for the first 242-tone RU, based on a value of the first RU allocation subfield being 304, the number of RAs set in the first A-MPDU is 2, and the RU or MRU to which the first A-MPDU is allocated is the first 242-tone RU,
wherein, for the second to fourth 242-tone RUs, based on a value of the second RU allocation subfield being one of 61 to 71, the number of RAs set in the second A-MPDU is 1, and the RU or MRU to which the second A-MPDU is allocated is the second to fourth 242-tone RUs using Multi User-Multi Input Multi Output (MU-MIMO).

17. The method of claim 13, wherein based on a bandwidth of the PPDU being 80 MHz and the 80 MHz including a first 484-tone RU and first and second 242-tone RUs,
wherein, for the first 484-tone RU, based on a value of the first RU allocation subfield being 306, the number of RAs set in the first A-MPDU is 2, and the RU or MRU to which the first A-MPDU is allocated is the first 484-tone RU,
wherein, for the first and second 242-tone RUs, based on a value of the second RU allocation subfield being one of 61 to 71, the number of RAs set in the second A-MPDU is 1, and the RU or MRU to which the second A-MPDU is allocated is the first and second 242-tone RUs using MU-MIMO.

18-20. (canceled)
